(19) United States
(12) Patent Application Publication
(10) Pub. No.: US 2025/0299419 A1
(43) Pub. Date: Sep. 25, 2025

(54) GRAPHICS PROCESSING

(71) Applicant: Arm Limited, Cambridge (GB)

(72) Inventors: Yoav Asher Levy, Kfar-Saba (IL); Mathieu Jean Joseph Robart, Papworth Everard (GB)

(73) Assignee: Arm Limited, Cambridge (GB)

(21) Appl. No.: 18/609,713

(22) Filed: Mar. 19, 2024

(51) Int. Cl. G06T 15/06; G06T 1/20

(52) U.S. Cl. CPC G06T 15/06; G06T 1/20

(57) ABSTRACT

A graphics processor that is operable to generate a render output by performing a ray tracing process in which rays are traced through a scene to be rendered includes a programmable execution unit operable to execute graphics processing programs to perform rendering that includes performing a ray tracing process, a ray tracing circuit operable to test rays against a ray tracing acceleration data structure for a ray tracing process, and a programmable processing unit associated with and in communication with the ray tracing circuit, and configured to execute processing programs to perform processing relating to the operation of the ray tracing circuit.

### BACKGROUND

The technology described herein relates to graphics processing systems, and in particular to the rendering of frames (images) for display using ray tracing.

FIG. 1 shows an exemplary system on-chip (SoC) graphics processing system 8 that comprises a host processor in the form of a central processing unit (CPU) 1, a graphics processor (GPU) 2, a display processor 3 and a memory controller 5.

As shown in FIG. 1, these units communicate via an interconnect 4 and have access to off-chip memory 6. In this system, the graphics processor 2 will render frames (images) to be displayed, and the display processor 3 will then provide the frames to a display panel 7 for display.

In use of this system, an application 13 such as a game, executing on the host processor (CPU) 1 will, for example, require the display of frames on the display panel 7. To do this, the application will submit appropriate commands and data to a driver 11 for the graphics processor 2 that is executing on the CPU 1. The driver 11 will then generate appropriate commands and data to cause the graphics processor 2 to render appropriate frames for display and to store those frames in appropriate frame buffers, e.g. in the main memory 6. The display processor 3 will then read those frames into a buffer for the display from where they are then read out and displayed on the display panel 7 of the display.

One rendering process that may be performed by a graphics processor is so-called “ray tracing”. Ray tracing is a rendering process which involves tracing the paths of rays of light from a viewpoint (sometimes referred to as a “camera”) back through sampling positions in an image plane into a scene, and simulating the effect of the interaction between the rays and objects in the scene. The output data value for a sampling position in the image (plane) is determined based on the object(s) in the scene intersected by the ray passing through the sampling position, and the properties of the surfaces of those objects. The ray tracing calculation is complex, and involves determining, for each sampling position, a set of (zero or more) objects within the scene which a ray passing through the sampling position intersects.

Ray tracing is considered to provide better, e.g. more realistic, physically accurate images than more traditional rasterisation rendering techniques, particularly in terms of the ability to capture reflection, refraction, shadows and lighting effects. However, ray tracing can be significantly more processing-intensive than traditional rasterisation, and so it is usually desirable to be able to accelerate ray tracing.

The Applicants believe that there remains scope for improved techniques for performing ray tracing using a graphics processor.

### BRIEF DESCRIPTION OF THE DRAWINGS

Embodiments of the technology described herein will now be described by way of example only and with reference to the accompanying drawings, in which:

FIG. 1 shows an exemplary graphics processing system;

FIG. 2 is a schematic diagram illustrating a “full” ray tracing process;

FIG. 3A and FIG. 3B show exemplary ray tracing acceleration data structures;

FIG. 4A and FIG. 4B are flow charts illustrating embodiments of a full ray tracing process;

FIG. 5 is a schematic diagram illustrating a “hybrid” ray tracing process;

FIG. 6 shows schematically an embodiment of a graphics processor that is in accordance with the technology described herein;

FIG. 7 and FIG. 8 show schematically in more detail elements of the graphics processor of FIG. 6; and

FIGS. 9, 10 and 11 are flow charts illustrating the operation of the graphics processor in embodiments of the technology described herein.

Like reference numerals are used for like elements in the Figures as appropriate.

### DETAILED DESCRIPTION

A first embodiment of the technology described herein comprises a graphics processor that is operable to generate a render output by performing a ray tracing process in which rays are traced through a scene to be rendered,
wherein the ray tracing process for a ray involves performing a traversal of at least one ray tracing acceleration data structure to determine geometry that is intersected or potentially intersected by the ray;
the graphics processor comprising:
a programmable execution unit operable to execute graphics processing program to perform rendering that includes performing a ray tracing process;
a ray tracing circuit operable to test rays against a ray tracing acceleration data structure for a ray tracing process; and
a programmable processing unit associated with and in communication with the ray tracing circuit, and configured to execute processing programs to perform processing relating to the operation of the ray tracing circuit.

A second embodiment of the technology described herein comprises a method of operating a graphics processor that is operable to generate a render output by performing a ray tracing process in which rays are traced through a scene to be rendered,
wherein the ray tracing process for a ray involves performing a traversal of at least one ray tracing acceleration data structure to determine geometry that is intersected or potentially intersected by the ray;
the graphics processor comprising:
a programmable execution unit operable to execute graphics processing program to perform rendering that includes performing a ray tracing process; and
a ray tracing circuit operable to test rays against a ray tracing acceleration data structure for a ray tracing process; and
a programmable processing unit associated with and in communication with the ray tracing circuit, and configured to execute processing programs to perform processing relating to the operation of the ray tracing circuit;
the method comprising:
loading a program for performing processing relating to the operation of the ray tracing circuit into program storage of the programmable processing unit; and
the programmable processing unit executing the program to perform processing relating to the operation of the ray tracing circuit.

The technology described herein relates to graphics processors that are capable of performing rendering using ray tracing, and in particular to a graphics processor that is operable to perform rendering using ray tracing and that includes, inter alia, a ray tracing circuit that is operable to (and configured to) test rays to be traced against respective ray tracing acceleration data structures (which represent and indicate geometry in a scene being rendered).

The graphics processor of the technology described herein further comprises, as well as the ray tracing circuit, a programmable processing unit that is associated with and in communication with the ray tracing circuit, and that is configured to execute processing programs to perform processing relating to the operation of the ray tracing circuit. As will be discussed in more detail below, the processing relating to the operation of the ray tracing circuit that the programmable processing unit can perform may comprise, for example, processing to facilitate improvements to the traversal of ray tracing acceleration data structures (e.g. in terms of their speed and/or efficiency), and/or the generation of further ray tracing acceleration data structures (e.g. treelets) for use then when performing ray tracing.

As will be discussed further below, the Applicants have recognised that a suitable programmable processing unit to perform such operations can be provided in association with a ray tracing circuit of a graphics processor, and for relatively little additional area cost (at least relative to the area of the ray tracing circuit itself), for example, to thereby provide a cost-effective mechanism for improving the performance of ray tracing on a graphics processor.

As well as the ray tracing circuit and its associated programmable processing unit (circuit), the graphics processor of the technology described herein also includes a programmable execution circuit (unit) operable to execute graphics processing programs, to, inter alia, perform rendering including ray tracing operations (and which programmable execution unit is separate to and distinct from (and in addition to) the programmable processing unit that is associated with the ray tracing circuit (and the ray tracing circuit)).

The programmable execution unit can be any suitable and desired programmable execution unit (circuit) that a graphics processor may contain. It should be (and is in an embodiment) operable to execute graphics shading programs to perform graphics processing operations. Thus the programmable execution unit will receive (execution) threads to be executed, and execute appropriate (graphics) (shading) programs for those threads to generate a desired output.

The graphics processor may comprise a single programmable execution unit, or may have plural execution units. Where there are a plural execution units, each execution unit can, and in an embodiment does, operate in the manner of the present embodiments. Where there are plural execution units, each execution unit may be provided as a separate circuit to other execution units of the graphics processor, or the execution units may share some or all of their circuits (circuit elements).

The (and each) programmable execution unit should, and in an embodiment does, comprise appropriate circuits (processing circuits/logic) for performing the operations required of the programmable execution unit.

The programmable execution unit of the graphics processor is in an embodiment operable to and configured to communicate appropriately with the ray tracing circuit, e.g., and in an embodiment, to trigger appropriate ray tracing acceleration data structure traversals (including ray-node intersection testing) for rays when required as part of an overall ray tracing operation, e.g., and in an embodiment, by sending (and exchanging) an appropriate message or messages to (with) the (separate) ray tracing circuit to trigger the appropriate ray tracing and ray-node test or tests.

This operation is in an embodiment achieved by including in a (shader) program that is to be executed by the programmable processing unit to perform a ray tracing operation, appropriate “ray-tracing” instructions that when executed will cause the programmable execution unit to trigger an appropriate ray tracing acceleration data structure traversal by the (separate) ray tracing circuit, e.g., and in embodiments, by triggering the execution unit to send an appropriate message to the ray tracing circuit (with the execution unit sending the message when it reaches (executes) the relevant instruction in the shader program).

Thus, in an embodiment, the overall ray tracing operation for a ray that is being used for a ray tracing process is initially performed by the programmable execution unit of the graphics processor executing a graphics processing (shader) program to perform the ray tracing process. However, as part of the ray tracing program execution, the programmable execution unit is operable to (and caused to) trigger the ray tracing circuit (unit) to perform traversal(s) of a ray tracing acceleration data structure or structures for the rays for which the ray tracing is being performed to determine the geometry, if any, that is intersected or potentially intersected by the rays.

The ray tracing circuit that is operable to test rays against a ray tracing acceleration data structure for a ray tracing process can operate and be configured as desired.

It is in an embodiment operable to (and configured to) at least perform ray-node intersection tests (to test rays to be traced against respective nodes of a ray tracing acceleration data structure), and correspondingly in an embodiment includes a ray testing circuit operable to perform ray intersection tests for nodes of a ray tracing acceleration data structure.

In an embodiment the ray tracing circuit is in the form of, and configured to perform the ray testing in a fixed-function manner, and that, e.g., and in an embodiment, acts as a hardware accelerator for (certain) ray tracing operations, in an embodiment including at least the ray-node intersection testing, and that is, e.g., and in an embodiment, associated with, and operates under the control of, the programmable execution unit of the graphics processor.

Thus the ray tracing circuit of the graphics processor in an embodiment is, a, in an embodiment (in an embodiment substantially) fixed-function, hardware unit (circuit) that is (more optimally) configured to perform ray tracing acceleration data structure traversals (and in particular ray-node intersection testing) for rays. The ray tracing circuit thus in an embodiment comprises an appropriate, in an embodiment fixed function, circuit or circuits to perform the required operations (although it may comprise and have some limited form of configurability, in use, e.g. if desired).

It would be possible in this regard for the ray tracing (and in particular the ray testing) circuit to be configured and operable to perform only some but not all of the ray-node intersection testing required for a ray tracing acceleration data structure traversal (with other embodiments of that testing being performed by appropriate shader program execution, for example). For example, the ray tracing circuit could be configured to perform ray-volume intersection testing for nodes of a ray tracing acceleration data structure, but not to perform any ray-geometry intersection testing (or vice-versa).

However, in an embodiment, the ray tracing circuit (the ray testing circuit of the ray tracing circuit) is configured and operable to perform any and all forms of ray intersection testing that may be required for a ray tracing operation. Thus in an embodiment, the ray tracing circuit can perform intersection testing both with volumes for nodes of a ray tracing acceleration data structure, and with geometry for a node of a ray tracing acceleration data structure. In an embodiment, the ray tracing circuit can perform intersection testing for and in respect of any type of node that a ray tracing acceleration data structure can comprise.

In an embodiment, the ray tracing (the ray testing) circuit is configured and operable to be able to perform plural ray node tests in parallel. This may be achieved, for example, and in an embodiment, by the ray testing circuit of the ray tracing circuit including a plurality of ray node testing circuits (units) (pipelines), each operable to perform its own respective ray node testing.

There may be a single or plural ray tracing circuits (units), e.g. such that plural programmable execution units share a given (or a single) ray tracing circuit (unit), and/or such that a given programmable execution unit has access to and can communicate with and use plural different ray tracing circuits (units).

Communication between the ray tracing circuit (unit) (s), etc., and the programmable execution unit(s) can be facilitated as desired. There is in an embodiment an appropriate communication (messaging) network for passing messages between the various units. This communication (messaging) network can operate according to any desired communications protocol and standard, such as using a suitable interconnect/messaging protocol.

The ray tracing circuit in an embodiment (also) includes (has access to) storage (that is in an embodiment local to the ray testing circuit) for storing data that will be used by the ray tracing circuit when performing ray tracing operations (in particular when performing ray-node or ray-geometry intersection tests).

This local storage for the ray tracing circuit can be configured in any suitable and desired manner. In an embodiment it is in the form of a cache or caches local to the ray tracing circuit (and in an embodiment local to any ray testing circuit of the ray tracing circuit).

The ray tracing circuit local storage should be, and is in an embodiment, physically (and logically) separate from any (main) memory of the data processing system, and should be, and is in an embodiment, storage that is internal to the graphics processor (and to the ray tracing circuit) that is performing the ray tracing processing and/or that can be accessed by the graphics processor (and in particular by the ray tracing circuit of the graphics processor) directly (without the need for a memory access unit (e.g. DMA) and not via any bus interface (in contrast to the (main) memory)).

The ray tracing circuit local storage (cache) can be used to store, and in an embodiment does store, any suitable and desired data that may be used by the ray tracing circuit when performing ray tracing (e.g. testing) processing.

In an embodiment, it is used to store, and in an embodiment stores, data representative of one or more, and in an embodiment of plural, nodes of a ray tracing acceleration data structure for use by the ray tracing circuit when testing rays against a ray tracing acceleration data structure for a ray tracing process.

The local storage (cache) of the ray tracing circuit could also or instead (and in an embodiment also) store data of rays to be traced (to be tested against nodes of a ray tracing acceleration data structure). In this case, the local storage (cache) in an embodiment stores the relevant data required for testing a ray against a node of a ray tracing acceleration data structure. Again, in an embodiment data representative of one or more, and in an embodiment of plural, rays to be traced for a ray tracing process can be stored in the local storage (cache) of the ray tracing circuit.

There may in this regard be separate local storage (caches) for storing node data and ray data, respectively, or there could, for example, be a single cache, in which both types of data are stored.

There is correspondingly in an embodiment an appropriate local storage (cache) controller or controllers (control circuit or circuits) that is operable to and configured to control the storage of data (e.g. of nodes and/or rays) in the local storage (cache) for the ray tracing circuit.

This controller may, for example, and in an embodiment, comprise and be configured to implement an appropriate local storage (cache) (data) replacement policy, for example, and in an embodiment, relating to the replacement of existing data in the cache when new data is required to be loaded into the local storage.

Thus, in an embodiment, the ray tracing circuit includes a cache replacement controller (control circuit) operable to and configured to control replacement of data in the cache.

Any suitable and desired cache replacement (eviction) policy can be used in this regard. In an embodiment a least recently used (LRU) replacement policy, and in an embodiment a pseudo-least recently used (PLRU) replacement policy is used.

The local storage controller or controllers in an embodiment also implements a data pre-fetching operation to “pre-fetch” data into the local storage (cache) before it will actually be used (where possible).

Thus, in an embodiment, the ray tracing circuit includes a cache pre-fetching controller (control circuit) operable to and configured to pre-fetch data into the local storage (cache) of the ray tracing circuit.

In an embodiment, the ray tracing circuit also includes a ray tracing scheduler (scheduling circuit) that is operable to and configured to schedule (and trigger) the performing of ray tracing operations by the ray tracing circuit, and in an embodiment operable to schedule (and control the order of) the testing of rays against nodes of a ray tracing acceleration data structure (i.e. to schedule the order in which rays to be tested will be tested by the ray tracing circuit and/or the order in which nodes to be tested by the ray tracing circuit will be tested). In one embodiment, the scheduler schedules the order in which rays are tested against a respective node of a ray tracing acceleration data structure, and then the order in which the nodes are tested.

Thus, in an embodiment, the ray tracing circuit includes a ray testing scheduler (scheduling circuit), operable to and configured to schedule the performing of ray tracing operations by the ray tracing circuit.

In an embodiment, the ray tracing circuit also includes a ray traversal mode controller (control circuit), operable to and configured to control the traversal mode (e.g. whether closer nodes or further nodes are tested first) that is used by the ray tracing circuit when performing ray tracing.

The ray tracing circuit (unit) is in an embodiment configured to, and operates to, return a result of its operation to the programmable execution unit (e.g., and in an embodiment, by returning for each ray an indication of how the ray tracing operation should proceed based on the geometry (if any) that was determined to be intersected by the ray, or correspondingly based on the ray tracing circuit (unit) determining that the ray does not intersect any geometry within the scene), with the overall ray tracing operation then continuing accordingly, e.g. by the programmable execution unit executing an appropriate shader routine, depending on the result that is returned.

The programmable processing unit that is associated with the ray tracing circuit in the technology described herein may be configured and implemented as desired, and can comprise any suitable and desired processing unit that is capable of and operable to execute processing programs, and that can be appropriately programmed to perform processing relating to the operation of the ray tracing circuit.

In an embodiment the programmable processing unit comprises an appropriate processor that can be programmed to perform the desired processing operations (that can execute programs to perform the desired processing operations). This processor can take any suitable and desired form.

In an embodiment, it comprises an appropriate (and in an embodiment (very) small) central processing unit (CPU) that can be programmed to perform the desired processing operations.

The programmable processing unit that is associated with the ray tracing circuit in the technology described herein is in an embodiment configured to execute and supports an instruction set that is specifically for (that is specifically selected for) the programmable processing unit, and that is, for example, and in an embodiment, different to the instruction set that the programmable execution unit of the graphics processor supports and is able to execute. Thus, in an embodiment the programmable processing unit is operable to, and configured to, execute programs using an instruction set different than an instruction set used by the programmable execution unit to execute (when executing) graphics processing programs.

In an embodiment, the instruction set for the programmable processing unit is an instruction set that is tailored to perform the required ray tracing “support” operations intended for the programmable processing unit, and thus will be, and is in an embodiment, a more limited, and/or specialised, instruction set than the instruction set for the programmable execution unit.

Correspondingly, there is in an embodiment a separate control flow for the programmable processing unit that is associated with the ray tracing circuit. Similarly, the programmable processing unit in an embodiment has a control flow that is independent of any control flow of the programmable execution unit of the graphics processor.

The programmable processing unit should, and in an embodiment does, comprise (suitable) storage for storing a program or programs (the program instructions) for the processing unit (with appropriate communication paths between the storage and the processor of the programmable processing unit).

The programmable processing unit should, and in an embodiment does, also comprise (suitable) storage for storing data to be used by the programmable processing unit when executing a program and/or (and in an embodiment and) for storing data that is generated by the programmable processing unit when executing a program.

Thus the method of the technology described herein in an embodiment further comprises loading data for performing processing relating to the operation of the ray tracing circuit into storage of the programmable processing unit (with the programmable processing unit then using that data when executing a program to perform processing relating to the operation of the ray tracing circuit).

The “data” storage may be separate to the “program” storage, or there may be “combined” storage that is used to store both programs (program instructions) and data for (use by or generated by) the programmable processing unit.

This (local) storage for the programmable processing unit can be configured in any suitable and desired manner. In an embodiment it is in the form of a cache or caches local to the programmable processing unit (and in an embodiment local to any processor of the programmable processing unit).

The programmable processing unit (local) storage should be, and is in an embodiment, physically (and logically) separate from any (main) memory of the data processing system, and should be, and is in an embodiment, storage that is internal to the graphics processor (and to the programmable processing unit). It is in an embodiment storage that can be accessed by the processor of the programmable processing unit directly (without the need for a memory access unit (e.g. DMA) and not via any bus interface (in contrast to the (main) memory)).

In an embodiment, the programmable processing unit comprises (the processor and (local) storage together form), in effect, a (small) system on-chip (SoC) associated with the ray tracing circuit and that can be used to perform processing relating to the operation of the ray tracing circuit.

As discussed above, the programmable processing unit associated with the ray tracing circuit is controlled to perform the desired processing by it executing appropriate programs that should be, and are in an embodiment, stored in appropriate storage of and associated with the programmable processing unit. It would be possible in this regard simply to load the programmable processing unit with a set of one or more desired programs to be executed, with the programmable processing unit then executing those programs as desired during use.

In an embodiment, it is possible to load new programs into the programmable processing unit for execution, for example, and in an embodiment, to replace an existing program or programs. This would then facilitate changing the operation of the programmable processing unit in use (“on-the-fly”), by updating the programmable processing unit instruction code when desired. This will then further provide a flexible and multi-purpose/multi-function mechanism for improving ray tracing operation on a graphics processor.

Thus in an embodiment, the technology described herein comprises loading a new program for performing processing relating to the operation of the ray tracing circuit into program storage of the programmable processing unit (in an embodiment to replace an existing program stored in the program storage of the programmable processing unit), and the programmable processing unit then executing the new program to perform processing relating to the operation of the ray tracing circuit.

The loading of programs (program instructions) and data required for program execution to the programmable processing unit can be performed in any suitable and desired manner. In an embodiment, this is performed by, and under the control of, the programmable execution unit of the graphics processor. For example, the programmable execution unit of the graphics processor may modify the stored program code for the programmable processing unit with modified code from (external) memory.

Thus in an embodiment, the programmable execution unit is operable to (and operates to) cause a program for performing processing relating to the operation of the ray tracing circuit to be loaded into the (program) storage of the programmable processing unit.

Correspondingly, the programmable execution unit is in an embodiment also operable to (and operates to) cause data required for the execution of a program by the programmable processing unit to be loaded into storage of the programmable processing unit.

The programmable processing unit can be caused to execute a program to perform processing relating to the operation of the ray tracing circuit in any suitable and desired manner. In an embodiment, this is again done by and under the control of the programmable execution unit. Thus, in an embodiment, when it is desired for the programmable processing unit to execute a program to perform processing relating to the operation of the ray tracing circuit, the programmable execution unit will communicate appropriately with the programmable processing unit to trigger the program execution.

When the programmable processing unit is to execute (is executing) a program to perform processing relating to the operation of the ray tracing circuit, then in an embodiment, the operation may, and in an embodiment is such that, for example, and in an embodiment, the appropriate program is triggered when a (and in an embodiment when each) new ray enters the ray tracing circuit (unit) and/or an appropriate “sub-unit” inside the ray tracing circuit (unit). Thus, for example, and in an embodiment, the programmable execution unit will “activate” program execution on the programmable processing unit, and then respective instances of that program execution by the programmable processing unit will be triggered as and when rays are processed by the ray tracing circuit.

Other arrangements would, of course, be possible.

To facilitate this operation, the programmable execution unit in an embodiment has an appropriate communications interface and path or paths to the programmable processing unit (i.e. to load programs or data to the programmable processing unit and to control the programmable processing unit). This is in an embodiment provided over and via the same communications interface (e.g. message fabric) that the programmable execution unit uses to communicate with other units of the graphics processor, such as other (hardware) accelerators of the graphics processor, such as, for example, and in an embodiment, the ray tracing circuit of the graphics processor.

Thus, in an embodiment, there is a communications interface (message fabric), via which the execution engine is operable to and configured to communicate (separately) with the ray tracing circuit and with the programmable processing unit that is associated with the ray tracing circuit.

The communication that is supported between the programmable execution unit and programmable processing unit associated with the ray tracing circuit in an embodiment comprises (and is limited to) any (the) communication that is necessary to facilitate and control operation of the programmable processing unit. Thus it in an embodiment supports, for example, and in an embodiment (and in an embodiment only), the loading of programs (program instructions) and data to the programmable processing unit, and the provision of appropriate control signals (e.g. messages) to the programmable processing unit.

The programs that are executed by the programmable processing unit can be generated as desired. For example, they may be generated in an “offline” manner, such that there is a library of suitable programs for execution by the programmable processing unit with, for example, the driver for the graphics processor selecting a program or programs to be executed by the programmable processing unit (and causing the selected program or programs to be loaded to the programmable processing unit for execution) in use, for example based on the ray tracing processing that the graphics processor is to perform.

Other arrangements would, of course, be possible.

The processing relating to the operation of the ray tracing circuit that the programmable processing unit that is associated with the ray tracing circuit is programmed to perform (and performs) can be any suitable and desired processing relating to the operation of the ray tracing circuit.

In an embodiment, the programmable processing unit is programmable to perform (and programmed to perform) processing relating to ray tracing acceleration data structure traversal operations that are being performed by the ray tracing circuit, and in an embodiment processing that is intended to (try to) improve the traversal operation of the ray tracing circuit.

Thus in an embodiment, the program that the programmable processing unit executes (and that is correspondingly stored in the program storage for the programmable processing unit) comprises a program relating to the traversal operation of the ray tracing circuit.

In this case, the programmable processing unit can (be programmed to) perform processing relating to any suitable and desired embodiment or embodiments of a ray tracing acceleration data structure traversal operation.

In an embodiment, the programmable processing unit is operable to (programmed to) perform (and performs) processing to provide information (hints/predictions) for improving (trying to improve) the ray tracing acceleration data structure traversal operation of the ray tracing circuit.

Such hints/predictions for trying to improve the ray tracing acceleration data structure traversal operation of the ray tracing circuit can comprise any suitable and desired hints/predictions for that purpose. In an embodiment, this comprises one or more of, and in an embodiment plural of, and in an embodiment all of: information for (trying to) improve the storing of (in an embodiment node and/or ray) data in the local storage of the ray tracing circuit, for example, and in an embodiment, so as to try to reduce the number and/or frequency of “misses” and/or stalls in that storage when performing a ray tracing acceleration data structure traversal; information for (trying to) improve the order (priority) for the performing of tests (e.g., and in an embodiment, ray-node tests) by the ray tracing circuit when performing a ray tracing acceleration data structure traversal operation for rays, for example, and in an embodiment, so as to assist/facilitate the selection of the order (priority) for scheduling ray-node tests to be performed by the ray tracing circuit, for example, and in an embodiment, so as to try to facilitate better ray testing circuit utilisation when performing such tests; and information relating to the traversal mode to be used when traversing a ray tracing acceleration data structure, so as to, for example, and in an embodiment, increase the likelihood of early termination for rays being traced and/or the amount of resume flow for “any hit” shader/non-opaque hits.

In an embodiment, the processing performed by the programmable processing unit relates to one or more of, and in an embodiment plural of, and in an embodiment all of: a priority in which data (e.g. node data) stored in a cache of the ray tracing circuit should be replaced (the cache replacement policy for a cache of the ray tracing circuit) (e.g. to (try to) reduce the number of cache misses); the control and selection of data to be pre-fetched into a cache of the ray tracing circuit (the cache pre-fetching operation for the ray tracing circuit) (e.g. to (try to) reduce the cache stalling time); the order (priority) for scheduling ray-node tests to be performed by the ray tracing circuit (e.g., and in an embodiment, in terms of the priority for performing different types of ray-node tests) (e.g., and in an embodiment, so as to try to improve the ray testing circuit utilisation); and the traversal mode to be used when traversing a ray tracing acceleration data structure (e.g., and in an embodiment, in terms of the order in which nodes of the ray tracing acceleration data structure are tested, e.g., and in an embodiment, relating to whether the closest node or the farthest node is tested first (so as to try to improve the amount of resume flow for “any hit” shader/non-opaque hits, as well as early termination for first hits)).

In an embodiment, and in order to facilitate this operation, the programmable processing unit is operable to and configured to (be able to) monitor and track the performance of ray tracing acceleration data structure traversals by the ray tracing circuit (which monitoring and tracking it can then in an embodiment (and in an embodiment does) use to determine information (hints) for then providing to the ray tracing circuit for (trying to) improve its ray tracing acceleration data structure traversal operation).

The monitoring and tracking of ray tracing acceleration data structure traversals being performed by the ray tracing circuit in this regard can monitor and track any suitable and desired information and performance relating to ray tracing acceleration data structure traversals (that in an embodiment can be used to identify potential improvements to the operation of the ray tracing circuit for the traversal operations being performed). Thus this may, for example, and in an embodiment, comprise the monitoring and tracking of information relating to the types of nodes being tested (and, e.g., and in an embodiment, the relative proportions of the different types of nodes being tested), and/or the order and/or frequency with which nodes are being tested for the traversal operations, etc.

In an embodiment, the tracking of the traversing of ray tracing acceleration data structures that is performed by the programmable processing unit comprises one or more of: identifying which nodes are the most used for the traversal being performed (which may then be, and is in an embodiment, used to prioritise node replacement in a node cache); and the relative proportions of different node types being tested (which may then be used, e.g., and in an embodiment, to prioritise testing of particular nodes (node types by the ray tracing circuit)).

In an embodiment, the programmable processing unit maintains a record of information per node type, so as to, for example, identify which nodes are the most used and what is the ratio between different node types being tested for the traversal operations.

In an embodiment, the programmable processing unit is operable to and configured to (be able to) observe (monitor) the traffic/workload on the ray tracing circuit, and executes a program that is operable to provide information for trying to improve the operation of the ray tracing circuit based on the observed traffic/workload of the ray tracing circuit.

The tracking/monitoring of the performance of ray tracing acceleration data structure traversals (and the corresponding sending of (control) information (“hints”) for those traversals) could be performed, for example, within and in relation to a single render output (frame) being generated (and in one embodiment that is what is done).

It could also or instead be performed over and for a suitable sequence of render outputs (frames) if desired (as there may be little geometry variation between a (relatively short) sequence of successive frames). Thus in another embodiment, the performance tracking/monitoring that is performed by the programmable processing unit (and the corresponding control/traversal “hints”) is performed over and in relation to a plurality of render outputs being generated. For example, the performance in one frame could be observed and used to set control information for the next frame.

In order to facilitate this operation, the programmable processing unit in an embodiment has appropriate communications path(s) and interface(s) with the ray tracing circuit, so as to, for example, and in an embodiment, allow it to monitor/track (determine information relating to) the performance of the ray tracing circuit when performing ray tracing acceleration data structure traversals, and, correspondingly, to provide information to the ray tracing circuit for the ray tracing circuit to then use to (try to) improve its ray tracing acceleration data structure traversal performance.

In an embodiment, the programmable processing unit has (appropriate) access to local storage (registers) that store (control) data for controlling the traversal operation of the ray tracing circuit (control registers of the ray tracing circuit), so as to allow the programmable processing unit to set and/or modify control information for the ray tracing circuit so as to try to improve the ray tracing traversal operation of the ray tracing circuit.

Correspondingly, the programmable processing unit in an embodiment has access to appropriate performance monitoring information (registers) that may be generated and stored by the ray tracing circuit when performing ray tracing acceleration data structure traversals, so that it can then use that information for trying to identify improvement information (hints) for the traversal operation.

Thus, in an embodiment, the programmable processing unit can read and/or write to (and in an embodiment read and write to) particular, in an embodiment selected, in an embodiment preferred, registers of the ray tracing circuit.

In an embodiment, these communication path(s) and interface(s) are provided by a dedicated interface between the programmable processing unit and the ray tracing circuit, i.e. such that there is (appropriate) direct communication between the programmable processing unit and the ray tracing circuit.

Thus the programmable processing unit in an embodiment has an appropriate, dedicated, interface for communication with the ray tracing circuit (such as, and in an embodiment, a suitable APB interface).

In the case where the ray tracing circuit includes a number of different processing and other units (elements) (as discussed above), then in an embodiment the programmable processing unit is configured to communicate with one or more and in an embodiment plural of the different units of the ray tracing circuit. For example, and in an embodiment, the programmable processing unit in an embodiment can communicate with one or more of, in an embodiment plural of, and in an embodiment all of: a cache replacement controller (control unit) of the ray tracing circuit (whether for node data, and/or ray data, etc., as desired); a cache pre-fetching controller of the ray tracing circuit (again, whether for node data, and/or ray data, etc., as desired); a ray testing scheduling circuit (scheduler) of the ray tracing circuit; and a ray traversal mode control circuit of the ray tracing circuit.

Other arrangements would, of course, be possible.

In an embodiment, the programmable processing unit is also or instead (and in an embodiment also) programmable to (and programmed to) generate ray tracing acceleration data structures.

In this case, it is in an embodiment programmable to (and programmed to) generate relatively small ray tracing acceleration data structures (treelets), e.g., and in an embodiment, for which the generated data can (all) be stored in the local data storage of the programmable processing circuit, such as, for example, and in an embodiment, ray tracing acceleration data structures comprising no more than a particular, in an embodiment selected, in an embodiment predetermined, number of primitives (triangles), such as (up to) 64, 128 or 256 triangles.

In this case, the programmable processing unit in an embodiment executes a program that executes a fixed algorithm for building a ray tracing acceleration data structure.

In this case, the programmable processing unit is in an embodiment configured to cause the ray tracing acceleration data structure that it has built to be written out to memory, from where it can then be, e.g., and in an embodiment, combined (agglomerated) with other ray tracing acceleration data structures (e.g. other such (small) ray tracing acceleration data structures) to provide an overall, desired “full” ray tracing acceleration data structure that will then be used when performing ray tracing.

Such combining (agglomeration) of the (small) acceleration data structures generated by the programmable processing unit(s) can be performed in any suitable and desired manner, for example, and in an embodiment, by an appropriate program executing on the graphics processor and/or a host processor of the overall data processing system that the graphics processor is part of.

In order to facilitate this operation, the programmable processing unit in an embodiment has an appropriate communications path and interface to allow data (the ray tracing acceleration data structure data) generated by the programmable processing unit to be written out from the programmable processing unit to memory. This can be achieved in any suitable and desired manner. For example, the programmable processing unit could have an appropriate interface to the memory system.

In an embodiment, the programmable processing unit has an appropriate communications interface to a load/store unit (circuit) of the graphics processor, which load/store unit then has access to and is operable to write data to and from the (overall) memory system (e.g. via an appropriate cache hierarchy).

Thus in an embodiment, the programmable processing unit is not configured (is other than configured) to be able to write data directly to the memory system (via e.g. the memory system cache hierarchy), but instead is configured to be in communication with, and write data out via, a load/store unit of the graphics processor, with that load/store unit of the graphics processor then having the appropriate interface to the memory system (e.g. to the memory system hierarchy) (e.g. to a level 2 cache of the overall memory system hierarchy) via which data generated by the programmable processing unit can be written out to the memory system.

As discussed above, the programmable processing unit should, and in an embodiment does, have appropriate communication with the other elements of the graphics processor that are necessary for its operation, such as, and in an embodiment (and in an embodiment only), the programmable execution unit, the ray tracing circuit and a load/store unit of the graphics processor.

In an embodiment, the programmable processing unit only has those communication interfaces that are necessary for its operation.

Subject to the operation in the manner of the technology described herein, the ray tracing operation that is performed in embodiments of the technology described herein can be performed in any suitable and desired manner, such as, and in an embodiment, in the normal manner for the graphics processor and graphics processing system in question.

The ray tracing can comprise any form of ray tracing based rendering, such as when a “full” ray tracing process is being used to render a scene, i.e. in which so-called “primary” rays are cast from a view point (the camera) through a sampling position in the image frame to determine the intersection of the rays with objects in the scene.

The technology described herein can also be used for so-called “hybrid” ray tracing rendering processes, e.g. in which both ray tracing and rasterisation processes are performed when performing rendering (e.g. in which only some of the steps of a full ray tracing process are performed, with a rasterisation process or processes being used to implement other steps of the “full” ray tracing process).

The ray tracing operation in an embodiment generally comprises performing a traversal of a ray tracing acceleration data structure for a ray or rays that are being used for the ray tracing process, to determine whether the respective ray intersects any geometry in the scene.

The ray tracing acceleration data structure(s) that are used and traversed in the technology described herein can be any suitable and desired ray tracing acceleration data structure(s) that are indicative of (that represent) the distribution of geometry for a scene to be rendered and that can be used (and traversed) to determine geometry for a scene to be rendered that may be intersected by a ray being projected into the scene, and can take any suitable and desired form.

The ray tracing acceleration data structures in an embodiment comprise a plurality of nodes, with each node representing (associated with) a respective one or more volumes within the scene being rendered.

In an embodiment the ray tracing acceleration data structure(s) comprises a tree structure, e.g. and in an embodiment comprising a plurality of end (leaf) nodes, at least some of which may represent a set of geometry (e.g. primitives) defined within the respective volume that the leaf node corresponds to, and with the non-leaf (non-end) nodes representing hierarchically-arranged larger volumes up to a root node at the top level of the tree structure that represents an overall volume for the scene in question that the tree structure corresponds to. Each non-leaf node is therefore in an embodiment a parent node for a respective set of plural child nodes, with the parent node volume encompassing the volumes of its respective child nodes.

In this case, the ray tracing acceleration data structure can thus be (and in an embodiment is) traversed by proceeding down the branches of the tree structure and testing the rays against a volume or volumes associated with a node at a first level of the tree structure to thereby determine which child nodes in the next (lower) level of the tree structure should be tested, and so on, down to the level of the respective leaf nodes at the ends of the branches of the tree structure.

Once it has been determined by performing such a traversal operation for a ray which end (leaf) nodes represent geometry that may be intersected by a ray, the actual geometry intersections for the ray for the geometry that occupies the volumes associated with the intersected end (leaf) nodes can be determined accordingly, e.g. by testing the ray for intersection with the individual units of geometry (e.g. primitives) defined for the scene that occupy the volumes associated with the leaf nodes. Once the geometry intersections for the rays being used to render a sampling position have been determined, it can then be (and in an embodiment is) determined what appearance the sampling position should have, and the sampling position rendered accordingly.

In an embodiment, the ray tracing acceleration data structure(s) comprises a bounding volume hierarchy, with the bounding volumes in an embodiment being axis aligned (cuboid) volumes. In an embodiment the ray tracing acceleration data structure(s) is a bounding volume hierarchy (BVH) tree.

Other suitable ray tracing acceleration data structures may also or instead be used, as desired.

In an embodiment, a ray tracing acceleration data structure can also indicate, e.g., and in an embodiment, at an end (leaf) node, a further ray tracing acceleration data structure that needs to be traversed (when the node in question is intersected by a ray).

For example, an initial ray tracing acceleration data structure could indicate further, e.g. finer resolution, ray tracing acceleration data structures that need to be considered for different volumes of the scene, with the traversal of the initial ray tracing acceleration data structure then determining a further ray tracing acceleration data structure or structures that need to be traversed depending upon which volumes for the scene the ray in question intersects. (Thus the ray tracing traversal operation could include transitions between different ray tracing acceleration data structures, such as transitions between different levels of detail (LOD), and/or between different levels of multi-level ray tracing acceleration data structures.)

The ray tracing acceleration data structure will, and in an embodiment does, store for each respective node the appropriate information for that node that will allow a ray to be tested against the node (and for the appropriate outcome depending upon the result of the testing with the node to be determined).

Other arrangements would, of course, be possible.

The ray tracing acceleration data structures that are used in the technology described herein can be generated and provided in any suitable and desired manner. For example, they may be previously determined and provided, e.g., as part of the definition of the scene to be rendered by the application that requires the graphics processing.

In an embodiment, the ray tracing acceleration data structures are generated by the graphics processor itself, e.g. based on an indication of geometry for the scene that is provided to the graphics processor, e.g. in a preliminary processing pass before the scene is rendered.

They could also or instead be generated by a CPU (e.g. host processor), e.g. based on an indication of geometry for the scene, e.g. in a preliminary processing pass before the scene is rendered.

Other arrangements would, of course, be possible.

The ray tracing acceleration data structure traversal operation for a ray in the technology described herein (to determine geometry for the scene to be rendered that may be intersected by the ray in question) can be performed in any suitable and desired manner.

The traversal process in an embodiment operates to traverse the ray tracing acceleration data structure(s) based on the position and direction of a ray, to determine whether there is any geometry in the volumes of the scene along the path of the ray (which could, accordingly, then potentially be intersected by the ray).

Accordingly, the traversal process will, and in an embodiment does, involve, for a ray that is being used for the ray tracing process, testing the ray for intersection with a volume or volumes associated with a node of the ray tracing acceleration data structure to, e.g., and in an embodiment, determine which (if any) of the associated child nodes of the node being tested is (potentially) intersected by the ray, and then subsequently testing the ray for intersection with the volume(s) associated with the (appropriate) (child) node(s) in the next (lower) level of the ray tracing acceleration data structure, and so on, down to the lowest level (end/leaf) nodes.

Once the traversal process has worked through the ray tracing acceleration data structure(s), by performing the required ray-volume intersection testing for the nodes, to determine which volumes (represented by end/leaf nodes) containing geometry may be intersected by a ray, the ray can then be further tested to determine the actual (ray-geometry) intersections (if any) with the geometry defined for the end (leaf) nodes in question. (If a ray does not in fact intersect any geometry defined for the scene, then an appropriate “miss” event may be, and is in an embodiment, determined for the ray.)

A suitable traversal record is in an embodiment maintained to track and manage which nodes should be tested during the traversal operation for a ray.

The ray-volume and ray-geometry intersection testing itself can generally be performed in any suitable way, as desired, e.g. in the normal way for such ray tracing operations and for the graphics processor and graphics processing system in question.

The determination of which geometry is intersected by a ray (or of a “miss” for a ray) is (in an embodiment) then used to determine how to continue the processing (ray tracing/rendering) operations for a sampling position in a frame that a ray corresponds to, such as triggering the tracing (casting) of a further (e.g. secondary) ray for the sampling position in question; and/or rendering (shading) the sampling position so as to provide an output colour value for the sampling position for the frame.

Once the ray tracing based rendering process has been completed for a sampling position, that will, and in an embodiment does, generate an appropriate set of output data for the sampling position, e.g., and in an embodiment, in the form of an appropriate set of colour (e.g. RGB) data, for the sampling position.

This will be done for each sampling position in the frame (thus the operation in the manner of the technology described herein is in an embodiment performed for plural, and in an embodiment for each, sampling position of the frame being rendered), so that a final output frame showing a view of the scene to be rendered will be generated, which output frame can then, e.g., be written out to memory and/or otherwise processed for further use, e.g. for display on a suitable display.

The process may then be repeated for a next frame (e.g. the next frame to be displayed), and so on.

In embodiments, the programmable execution unit, ray tracing circuit and programmable processing unit associated with and in communication with the ray tracing circuit are all part of (and respective functional blocks of) a given processing (shader) core of the graphics processor, and the graphics processor may, and in an embodiment does, comprise a plurality of such processing (shader) cores, some or all of which will include ray tracing circuits having associated programmable processing units.

Thus, in an embodiment the graphics processor comprises a plurality of processing (shader) cores (elements), two or more of which each comprise a respective programmable execution unit, a respective ray tracing circuit, and a respective programmable processing unit.

Correspondingly, a further embodiment of the technology described herein comprises a processing (shader) core for a graphics processor, comprising:
a programmable execution unit operable to execute graphics processing programs to perform rendering that includes performing a ray tracing process;
a ray tracing circuit operable to test rays against a ray tracing acceleration data structure for a ray tracing process; and
a programmable processing unit associated with and in communication with the ray tracing circuit, and configured to execute processing programs to perform processing relating to the operation of the ray tracing circuit.

As will be appreciated by those skilled in the art this embodiment of the technology described herein can, and in an embodiment does, include any one or more or all of the preferred and optional features of the technology described herein described herein, as appropriate.

The technology described herein can be used for all forms of output that a graphics processor may output. Thus, it may be used when generating frames for display, for render-to-texture outputs, etc. The output from the graphics processor is, in an embodiment, exported to external, e.g. main, memory, for storage and use.

Subject to the requirements for operation in the manner of the technology described herein, the graphics processor can otherwise have any suitable and desired form or configuration of graphics processor and comprise and execute any other suitable and desired processing elements, circuits, units and stages that a graphics processor may contain, and execute any suitable and desired form of graphics processing pipeline.

In an embodiment, the graphics processor is part of an overall graphics (data) processing system that includes, e.g., and in an embodiment, a host processor (CPU) that, e.g., executes applications that require processing by the graphics processor. The host processor will send appropriate commands and data to the graphics processor to control it to perform graphics processing operations and to produce graphics processing output required by applications executing on the host processor. To facilitate this, the host processor should, and, in an embodiment does, also execute a driver for the graphics processor and a compiler or compilers for compiling programs to be executed by the programmable execution unit of the graphics processor.

The overall graphics processing system may, for example, include one or more of: a host processor (central processing unit (CPU)), the graphics processor (processing unit), a display processor, a video processor (codec), a system bus, and a memory controller.

The graphics processor and/or graphics processing system may also comprise, and/or be in communication with, one or more memories and/or memory devices that store the data described herein, and/or the output data generated by the graphics processor, and/or store software (e.g. (shader) programs) for performing the processes described herein.

Thus the graphics processor in an embodiment has an appropriate interface to, and communication with memory (a memory system) of or accessible to the graphics processor, for accessing, inter alia, ray tracing acceleration data structures stored in the memory (e.g., and in an embodiment, via an appropriate cache hierarchy).

The memory and memory system is in an embodiment a main memory of or available to the graphics processor, such as a memory that is dedicated to the graphics processor, or a main memory of a data processing system that the graphics processor is part of. In an embodiment, the memory system includes an appropriate cache hierarchy intermediate the main memory of the memory system and the (local) storage of graphics processor.

The graphics processor and/or graphics processing system may also be in communication with a display for displaying images based on the data generated by the graphics processor.

The technology described herein also extends to an overall graphics processing system and the operation of that system.

Each embodiment of the technology described herein can, and in embodiments does, include one or more, and in embodiments all, features of other embodiments of the technology described herein, as appropriate.

The technology described herein can be implemented in any suitable system, such as a suitably configured micro-processor based system. In embodiments, the technology described herein is implemented in a computer and/or micro-processor based system. The technology described herein is in embodiments implemented in a portable device, such as, and in embodiments, a mobile phone or tablet.

The technology described herein is applicable to any suitable form or configuration of graphics processor and graphics processing system, such as graphics processors (and systems) having a “pipelined” arrangement (in which case the graphics processor executes a rendering pipeline).

In embodiments, the various functions of the technology described herein are carried out on a single data processing platform that generates and outputs data, for example for a display device.

In some embodiments, the graphics processor and graphics processing system comprises, and/or is in communication with, one or more memories and/or memory devices that store the data described herein, and/or store software for performing the processes described herein. The graphics processor and graphics processing system may also be in communication with a host microprocessor, and/or with a display for displaying images based on the data generated by the graphics processor and graphics processing system.

The various functions of the technology described herein can be carried out in any desired and suitable manner. For example, the functions of the technology described herein can be implemented in hardware or software, as desired. Thus, for example, the various circuitry, functional elements, and stages, of the technology described herein may comprise a suitable processor or processors, controller or controllers, functional units, circuitry, circuit(s), processing logic, microprocessor arrangements, etc., that are operable to perform the various functions, etc., such as appropriately dedicated hardware elements (processing circuit(s)) and/or programmable hardware elements (processing circuit(s)) that can be programmed to operate in the desired manner.

It should also be noted here that, as will be appreciated by those skilled in the art, the various functions, etc., of the technology described herein may be duplicated and/or carried out in parallel on a given processor. Equally, the various processing stages may share processing circuit(s), etc., if desired.

Furthermore, any one or more or all of the processing stages of the technology described herein may be embodied as processing stage circuitry/circuits, e.g., in the form of one or more fixed-function units (hardware) (processing circuitry/circuits), and/or in the form of programmable processing circuitry/circuits that can be programmed to perform the desired operation. Equally, any one or more of the processing stages and processing stage circuitry/circuits of the technology described herein may be provided as a separate circuit element to any one or more of the other processing stages or processing stage circuitry/circuits, and/or any one or more or all of the processing stages and processing stage circuitry/circuits may be at least partially formed of shared processing circuitry/circuits.

Subject to any hardware necessary to carry out the specific functions discussed above, the components of the graphics processing system can otherwise include any one or more or all of the usual functional units, etc., that such components include.

It will also be appreciated by those skilled in the art that all of the described embodiments of the technology described herein can include, as appropriate, any one or more or all of the optional features described herein.

The methods in accordance with the technology described herein may be implemented at least partially using software e.g. computer programs. It will thus be seen that when viewed from further embodiments the technology described herein provides computer software specifically adapted to carry out the methods herein described when installed on a data processor, a computer program element comprising computer software code portions for performing the methods herein described when the program element is run on a data processor, and a computer program comprising code adapted to perform all the steps of a method or of the methods herein described when the program is run on a data processing system. The data processing system may be a microprocessor, a programmable FPGA (Field Programmable Gate Array), etc.

The technology described herein also extends to a computer software carrier comprising such software which when used to operate a data processor, renderer or other system comprising a data processor causes in conjunction with said data processor said processor, renderer or system to carry out the steps of the methods of the technology described herein. Such a computer software carrier could be a physical storage medium such as a ROM chip, CD ROM, RAM, flash memory, or disk, or could be a signal such as an electronic signal over wires, an optical signal or a radio signal such as to a satellite or the like.

It will further be appreciated that not all steps of the methods of the technology described herein need be carried out by computer software and thus from a further broad embodiment the technology described herein provides computer software and such software installed on a computer software carrier for carrying out at least one of the steps of the methods set out herein.

The technology described herein may accordingly suitably be embodied as a computer program product for use with a computer system. Such an implementation may comprise a series of computer readable instructions fixed on a tangible, non-transitory medium, such as a computer readable medium, for example, diskette, CD ROM, ROM, RAM, flash memory, or hard disk. It could also comprise a series of computer readable instructions transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink wrapped software, pre-loaded with a computer system, for example, on a system ROM or fixed disk, or distributed from a server or electronic bulletin board over a network, for example, the Internet or World Wide Web.

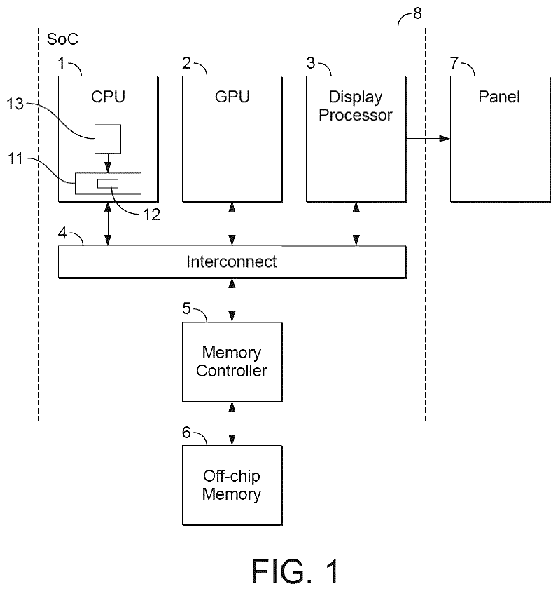

The present embodiments relate to the operation of a graphics processor, e.g. in a graphics processing system as illustrated in FIG. 1, when performing rendering of a scene to be displayed using a ray tracing-based rendering process.

Ray tracing is a rendering process which involves tracing the paths of rays of light from a viewpoint (sometimes referred to as a “camera”) back through sampling positions in an image plane (which is the frame being rendered) into a scene, and simulating the effect of the interaction between the rays and objects in the scene. The output data value e.g. colour of a sampling position in the image is determined based on the object(s) in the scene intersected by the ray passing through the sampling position, and the properties of the surfaces of those objects. The ray tracing process thus involves determining, for each sampling position, a set of (zero or more) objects within the scene which a ray passing through the sampling position intersects.

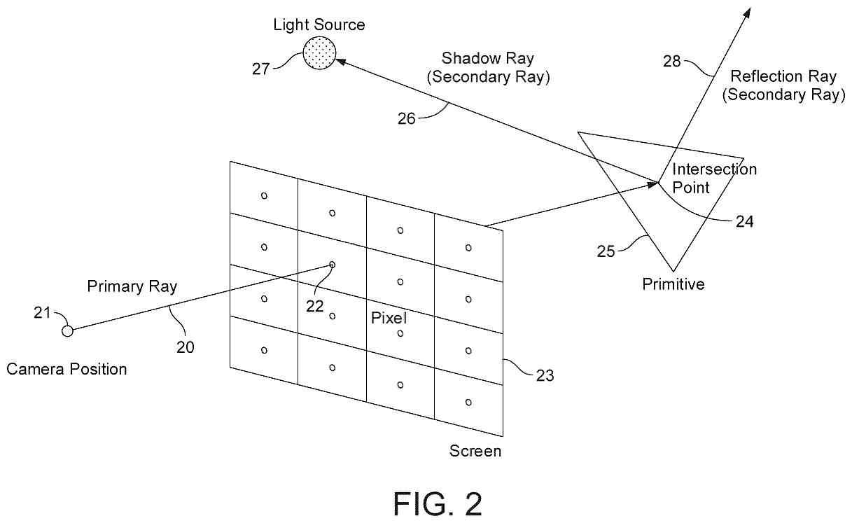

FIG. 2 illustrates an exemplary “full” ray tracing process. A ray 20 (the “primary ray”) is cast backward from a viewpoint 21 (e.g. camera position) through a sampling position 22 in an image plane (frame) 23 into the scene that is being rendered. The point 24 at which the ray 20 first intersects an object, which in this case is represented by a triangle primitive 25, in the scene is identified. This first intersection will be with the object in the scene closest to the sampling position.

A secondary ray in the form of shadow ray 26 may be cast from the first intersection point 24 to a light source 27. Depending upon the material of the surface of the object, another secondary ray in the form of reflected ray 28 may be traced from the intersection point 24. If the object is, at least to some degree, transparent, then a refracted secondary ray may be considered.

Such casting of secondary rays may be used where it is desired to add shadows and reflections into the image. A secondary ray may be cast in the direction of each light source (and, depending upon whether or not the light source is a point source, more than one secondary ray may be cast back to a point on the light source).

In the example shown in FIG. 2, only a single bounce of the primary ray 20 is considered, before tracing the reflected ray back to the light source. However, a higher number of bounces may be considered if desired.

The output data for the sampling position 22 i.e. a colour value (e.g. RGB value) thereof, is then determined taking into account the interactions of the primary, and any secondary, ray(s) cast, with objects in the scene. The same process is conducted in respect of each sampling position to be considered in the image plane (frame) 23.

Thus, different types of rays may be traced, depending on the scene, etc. Primary, reflection and refraction rays may be referred to as “closest-hit rays”, since they are typically traced until intersecting geometry closest to the ray's origin is found (or until it is determined that the ray does not intersect any geometry). On the other hand, shadow rays may be referred to as “first-hit rays” or “visibility rays”, as they can typically be terminated as soon as they are found to intersect any geometry (or until it is determined that the ray does not intersect any geometry).

In order to facilitate such ray tracing processing, in the present embodiments, acceleration data structures indicative of the geometry (e.g. objects) in scenes to be rendered are used when determining the intersection data for the ray(s) associated with a sampling position in the image plane to identify a subset of the geometry which a ray may intersect.

The ray tracing acceleration data structure represents and indicates the distribution of geometry (e.g. objects) in the scene being rendered, and in particular the geometry that falls within respective (sub-) volumes in the overall volume of the scene (that is being considered).

In the present embodiments, a ray tracing acceleration data structure is in the form of one or more Bounding Volume Hierarchy (BVH) trees. The use of BVH trees allows and facilitates testing a ray against a hierarchy of bounding volumes until a leaf node is found. It is then only necessary to test the geometry associated with the particular leaf node for intersection with the ray.

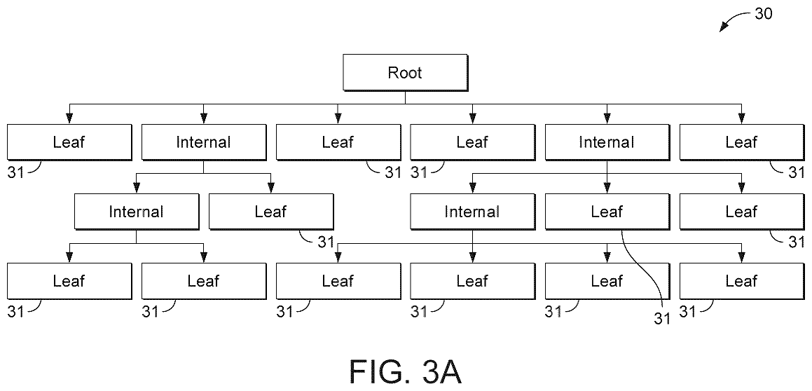

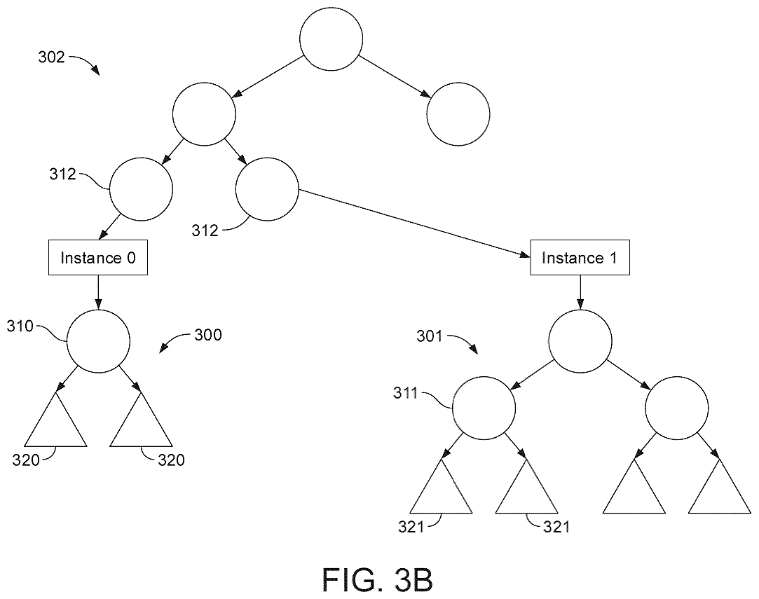

FIG. 3A shows an exemplary BVH tree 30, constructed by enclosing a volume in an axis-aligned bounding volume (AABV), e.g. a cube, and then recursively subdividing the bounding volume into successive sub-AABVs according to any suitable and desired subdivision scheme, until a desired smallest subdivision (volume) is reached.

In this example, the BVH tree 30 is a relatively “wide” tree wherein each bounding volume is subdivided into up to six sub-AABVs. However, in general, any other suitable tree structure may be used, and a given node of the tree may have any suitable and desired number of child nodes.

Thus, each node in the BVH tree 30 will have a respective volume associated with it, with the end, leaf nodes 31 each representing a particular smallest subdivided volume, and any parent node representing, and being associated with, the volume of its child nodes.

A complete scene may be represented by a single BVH tree, e.g. with the tree storing the geometry for the scene in world space. In this case, each leaf node of the BVH tree 30 may be associated with the geometry defined for the scene that falls, at least in part, within the volume that the leaf node corresponds to (e.g. whose centroid falls within the volume in question). The leaf nodes 31 may represent unique (non-overlapping) subsets of primitives defined for the scene falling within the corresponding volumes for the leaf nodes 31.

In the present embodiments, a two-level ray tracing acceleration data structure is used. FIG. 3B shows an exemplary two-level ray tracing acceleration data structure in which each instance or object is associated with a respective bottom-level acceleration structure (BLAS) 300, 301, which in the present embodiments is in the form of a respective BVH tree that stores geometry in model space, with each leaf node 310, 311 of the BVH tree representing a unique subset of primitives 320, 321 defined for the instance or object falling within the corresponding volume.

A separate top-level acceleration structure (TLAS) 302 then contains references to the set of bottom-level acceleration structures (BLAS), together with a respective set of shading and transformation information for each bottom-level acceleration structure (BLAS). In the present embodiments, the top-level acceleration structure (TLAS) 302 is defined in a “top-level” (e.g. world) space and is in the form of a BVH tree having leaf nodes 312 that each point to one or more of the bottom-level acceleration structures (BLAS) 300, 301.

Other forms of ray tracing acceleration data structure would be possible.

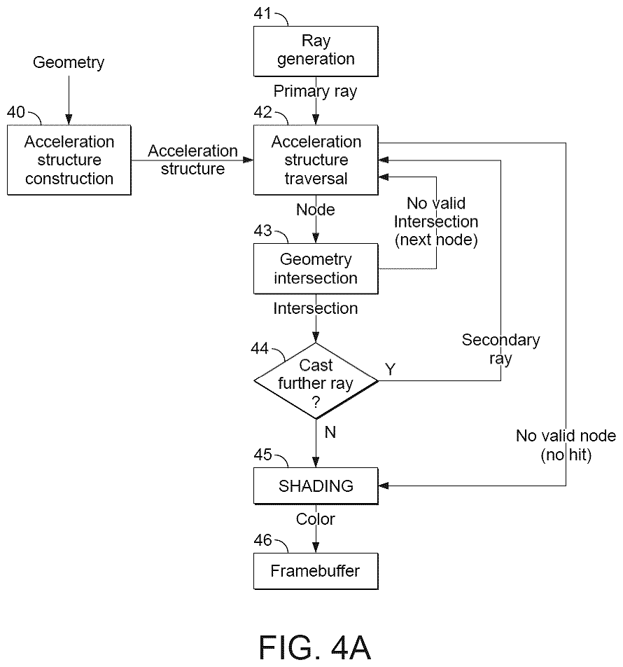

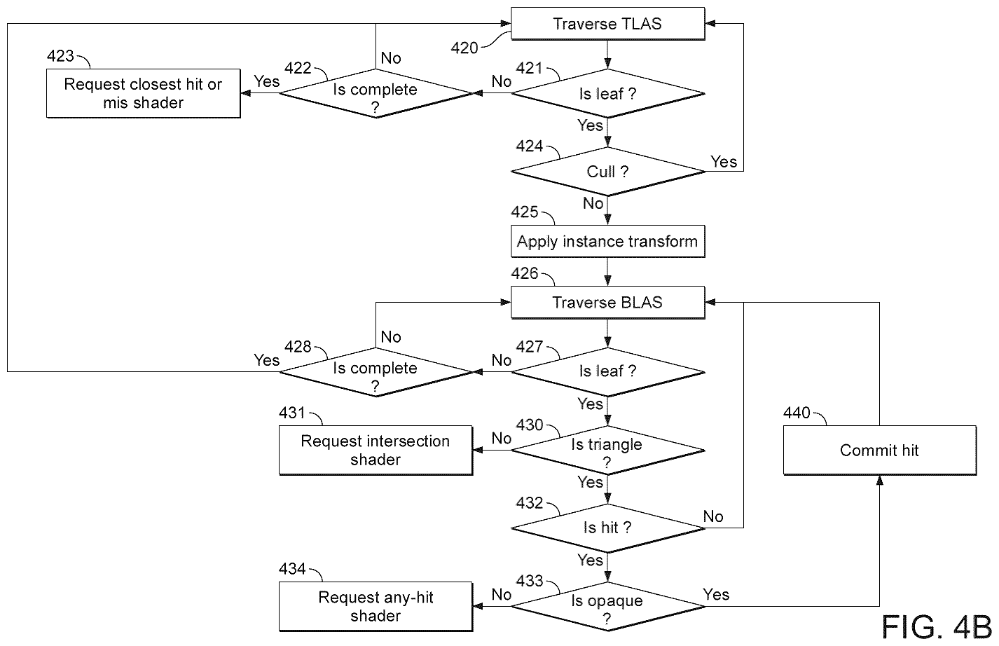

FIG. 4A is a flow chart showing an overall ray tracing process that may be performed on and by the graphics processor 2.

First, the geometry of the scene is analysed and used to obtain an acceleration data structure (step 40), for example in the form of one or more BVH tree structures, as discussed above. This can be done in any suitable and desired manner, for example by means of an initial processing pass on the graphics processor 2.

A primary ray is then generated, passing from a camera through a particular sampling position in an image plane (frame) (step 41). The acceleration data structure is then traversed for the primary ray (step 42), and the leaf node corresponding to the first volume that the ray passes through which contains geometry which the ray potentially intersects is identified. It is then determined whether the ray intersects any of the geometry, e.g. primitives, (if any) in that leaf node (step 43).

If no (valid) geometry which the ray intersects can be identified in the node, the process returns to step 42, and the ray continues to traverse the acceleration data structure and the leaf node for the next volume that the ray passes through which may contain geometry with which the ray intersects is identified, and a test for intersection performed at step 43.

This is repeated for each leaf node that the ray (potentially) intersects, until geometry that the ray intersects is identified.

When geometry that the ray intersects is identified, it may be determined whether that intersection is the “closest” hit so far, for example, and if so, for example, then determined whether to cast any further (secondary) rays for the primary ray (and thus sampling position) in question (step 44). This may be based, e.g., and in an embodiment, on the nature of the geometry (e.g. its surface properties) that the ray has been found to intersect, and the complexity of the ray tracing process being used.

Thus, as shown in FIG. 4A, one or more secondary rays may be generated emanating from the intersection point (e.g. a shadow ray(s), a refraction ray(s) and/or a reflection ray(s), etc.). Steps 42, 43 and 44 are then performed in relation to each secondary ray. A secondary ray may be generated as part of a shading process, for example.

Once there are no further rays to be cast, a shaded colour for the sampling position that the ray(s) correspond to is then determined based on the result(s) of the casting of the primary ray, and any secondary rays considered (step 45), taking into account the properties of the surface of the object at the primary intersection point, any geometry intersected by secondary rays, etc. The shaded colour for the sampling position is then stored in the frame buffer (step 46).

If no (valid) node which may include geometry intersected by a given ray (whether primary or secondary) can be identified in step 42 (and there are no further rays to be cast for the sampling position), the process moves to step 45, and shading is performed. In this case, the shading is in an embodiment based on some form of “default” shading operation that is to be performed in the case that no intersected geometry is found for a ray. This could comprise, e.g., simply allocating a default colour to the sampling position, and/or having a defined, default geometry to be used in the case where no actual geometry intersection in the scene is found, with the sampling position then being shaded in accordance with that default geometry. Other arrangements are possible.

This process is performed for each sampling position to be considered in the image plane (frame). Once the final output value for the sampling position in question has been generated, the processing in respect of that sampling position is completed. A next sampling position may then be processed in a similar manner, and so on, until all the sampling positions for the frame have been appropriately shaded. The frame may then be output, e.g. for display, and the next frame to be rendered processed in a similar manner, and so on.

FIG. 4B is a flow chart showing in more detail acceleration structure traversal in the case of a two-level acceleration data structure, e.g. as described above with reference to FIG. 3B. As shown in FIG. 4B, in this case, acceleration structure traversal begins with TLAS traversal (step 420), and TLAS traversal continues in search of a TLAS leaf node (steps 421, 422). If no TLAS leaf node can be identified, a “default” shading operation (“miss shader”) may be performed (step 423), e.g. as described above.

When (at step 421) a TLAS leaf node is identified, it is determined whether that leaf node can be culled from further processing (step 424). If it can be culled from further processing, the process returns to TLAS traversal (step 420).

If the TLAS leaf node cannot be culled from further processing, instance transform information associated with the leaf node is used to transform the ray to the appropriate space for BLAS traversal (step 425). BLAS traversal then begins (step 426), and continues in search of a BLAS leaf node (steps 427, 428). If no BLAS leaf node can be identified, the process may return to TLAS traversal (step 420).

In the present embodiments, geometry associated with a BLAS leaf node can be in the form of a set of triangle primitives or an axis aligned bounding box (AABB) primitive. When (at step 427) a BLAS leaf node is identified, it is determined whether geometry associated with the leaf node is in the form of a set of triangle primitives or an axis aligned bounding box (AABB) primitive (step 430).

As shown in FIG. 4B, when an axis aligned bounding box (AABB) primitive is encountered, execution of a shader program (“intersection shader”) that defines a procedural object encompassed by the axis aligned bounding box (AABB) is triggered (step 431) to determine whether a ray intersects the procedural object defined by the shader program. On the other hand, when a set of triangle primitives is encountered, determining whether a ray intersects any of the triangle primitives is performed by fixed function circuitry (circuit(s)) (step 432). Other arrangements would be possible.

If no (valid) triangle primitives which the ray intersects can be identified in the node, the process returns to BLAS traversal (step 426).

If a ray is found to intersect a triangle primitive 25, it is determined whether or not the triangle primitive 25 is opaque (step 433). In the case of the triangle primitive being found to be non-opaque, execution of an appropriate shader program (“any-hit shader”) may be triggered (step 434). Otherwise, in the case of the triangle primitive being found to be opaque, the intersection can be committed without executing a shader program (step 440). Traversal for one or more secondary rays may be triggered, as appropriate, e.g. as discussed above.

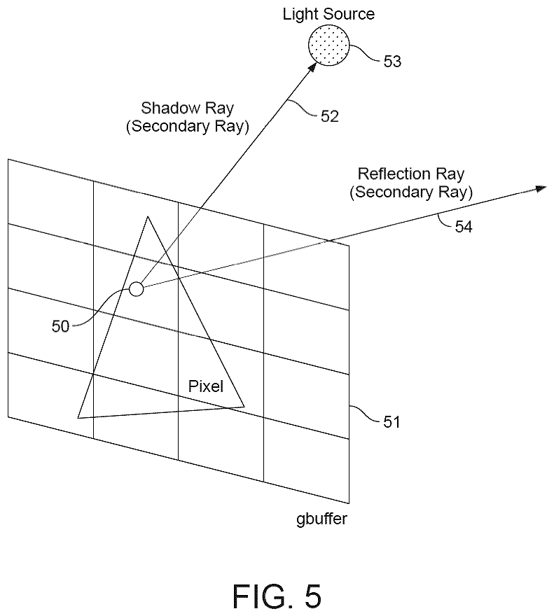

FIG. 5 shows an alternative ray tracing process which may be used in embodiments of the technology described herein, in which only some of the steps of the full ray tracing process described above are performed. Such an alternative ray tracing process may be referred to as a “hybrid” ray tracing process.

In this process, as shown in FIG. 5, the first intersection point 50 for each sampling position in the image plane (frame) is instead determined first using a rasterisation process and stored in an intermediate data structure known as a “G-buffer” 51. Thus, the process of generating a primary ray for each sampling position, and identifying the first intersection point of the primary ray with geometry in the scene, is replaced with an initial rasterisation process to generate the “G-buffer”. The G-buffer includes information indicative of the depth, colour, normal and surface properties (and any other appropriate and desired data, e.g. albedo, etc.) for each first (closest) intersection point for each sampling position in the image plane (frame).

Secondary rays, e.g. shadow ray 52 to light source 53, and reflection ray 54, may then be cast starting from the first intersection point 50, and the shading of the sampling positions determined based on the properties of the geometry first intersected, and the interactions of the secondary rays with geometry in the scene.

Referring to the flowchart of FIG. 4A, in such a hybrid process, the initial pass of steps 41, 42 and 43 of the full ray tracing process for a primary ray will be omitted, as there is no need to cast primary rays and determine their first intersection with geometry in the scene. The first intersection point data for each sampling position is instead obtained from the G-buffer.

The process may then proceed to the shading stage 45 based on the first intersection point for each pixel obtained from the G-buffer, or where secondary rays emanating from the first intersection point are to be considered, these will need to be cast in the manner described by reference to FIG. 4. Thus, steps 42, 43 and 44 will be performed in the same manner as previously described in relation to the full ray tracing process for any secondary rays.

The colour determined for a sampling position will be written to the frame buffer in the same manner as step 46 of FIG. 4A, based on the shading colour determined for the sampling position based on the first intersection point (as obtained from the G-buffer), and, where applicable, the intersections of any secondary rays with objects in the scene, determined using ray tracing.

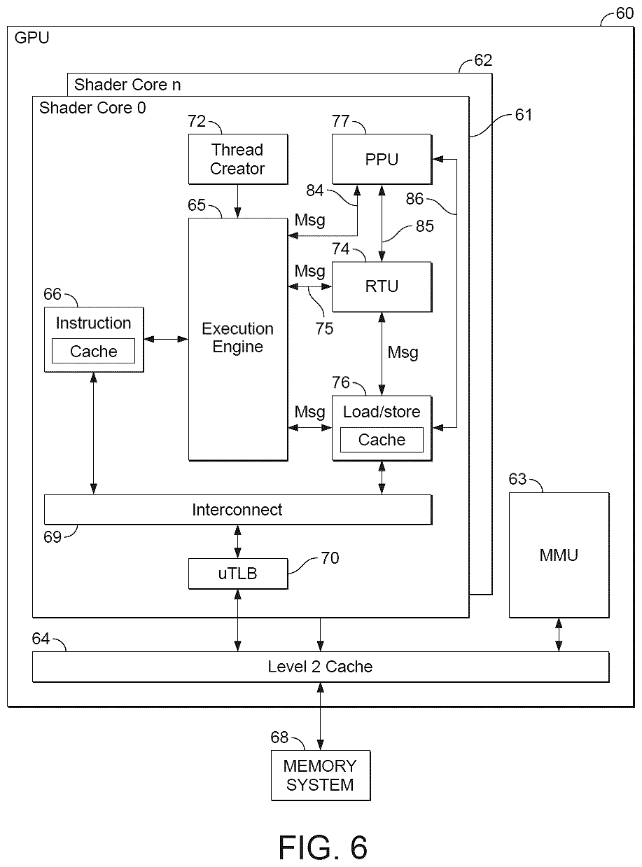

FIG. 6 shows schematically the relevant elements and components of a graphics processor (GPU) 2, 60 of the present embodiments.

As shown in FIG. 6, the GPU 60 includes one or more shader (processing) cores 61, 62 together with a memory management unit (“MMU”) 63 and a level 2 cache 64 which is operable to communicate with an off-chip memory system 68 (e.g. via an appropriate interconnect and (dynamic) memory controller).

FIG. 6 shows schematically the relevant configuration of one shader core 61, but as will be appreciated by those skilled in the art, any further shader cores of the graphics processor 60 will be configured in a corresponding manner.

The graphics processor (GPU) shader cores 61, 62 are programmable processing units (circuits) that perform processing operations by running small programs for each “item” in an output to be generated such as a render target, e.g. frame. An “item” in this regard may be, e.g. a vertex, one or more sampling positions, etc. The shader cores will process each “item” by means of one or more execution threads which will execute the instructions of the shader program(s) in question for the “item” in question. Typically, there will be multiple execution threads each executing at the same time (in parallel).

FIG. 6 shows the main elements of the graphics processor 60 that are relevant to the operation of the present embodiments. As will be appreciated by those skilled in the art there may be other elements of the graphics processor 60 that are not illustrated in FIG. 6. It should also be noted here that FIG. 6 is only schematic, and that, for example, in practice the shown functional units may share significant hardware circuits, even though they are shown schematically as separate units in FIG. 6. It will also be appreciated that each of the elements and units, etc., of the graphics processor as shown in FIG. 6 may, unless otherwise indicated, be implemented as desired and will accordingly comprise, e.g., appropriate circuits (processing logic), etc., for performing the necessary operation and functions.

As shown in FIG. 6, each shader core of the graphics processor 60 includes an appropriate programmable execution unit (execution engine) 65 that is operable to execute graphics shader programs for execution threads to perform graphics processing operations.

The shader core 61 also includes an instruction cache 66 that stores instructions to be executed by the programmable execution unit 65 to perform graphics processing operations. The instructions to be executed will, as shown in FIG. 6, be fetched from the memory system 68 via an interconnect 69 and a micro-TLB (translation lookaside buffer) 70.

The shader core 61 also includes an appropriate load/store unit 76 in communication with the programmable execution unit 65, that is operable, e.g., to load into an appropriate cache, data, etc., to be processed by the programmable execution unit 65, and to write data back to the memory system 68 (for data loads and stores for programs executed in the programmable execution unit). Again, such data will be fetched/stored by the load/store unit 76 via the interconnect 69 and the micro-TLB 70.

In order to perform graphics processing operations, the programmable execution unit 65 will execute graphics shader programs (sequences of instructions) for respective execution threads (e.g. corresponding to respective sampling positions of a frame to be rendered). Accordingly, as shown in FIG. 6, the shader core 61 further comprises a thread creator (generator) 72 operable to generate execution threads for execution by the programmable execution unit 65.

As shown in FIG. 6, the shader core 61 in this embodiment also includes a ray tracing circuit (unit) (“RTU”) 74, which is in communication with the programmable execution unit 65, and which is operable to perform the required ray-volume testing during the ray tracing acceleration data structure traversals (e.g. the operation of steps 420 and 426 of FIG. 4B) for rays being processed as part of a ray tracing-based rendering process, in response to messages 75 received from the programmable execution unit 65.

In the present embodiments the RTU 74 is also operable to perform the required ray-primitive testing (e.g. the operation of step 432 of FIG. 4B). The RTU 74 is also able to communicate with the load/store unit 76 for loading in the required data for such intersection testing.

In the present embodiments, the RTU 74 of the graphics processor is a (substantially) fixed-function hardware unit (circuit) that is configured to perform the required ray-volume and ray-primitive intersection testing during a traversal of a ray tracing acceleration data structure to determine geometry for a scene to be rendered that may be (and is) intersected by a ray being used for a ray tracing operation. However, some amount of configurability may be provided. Other arrangements would be possible. For example, ray-volume and/or ray-primitive intersection testing may be performed by the programmable execution unit 65 (e.g. in software).

As shown in FIG. 6, in the present embodiments the shader core 61 also includes, in accordance with the technology described herein, a programmable processing unit 77 that is associated with and in communication with the ray tracing circuit (RTU) 74. As will be discussed in more detail below, this programmable processing unit 77 can be programmed to, and is caused to execute programs to, perform processing operations relating to the operation of the RTU 74.

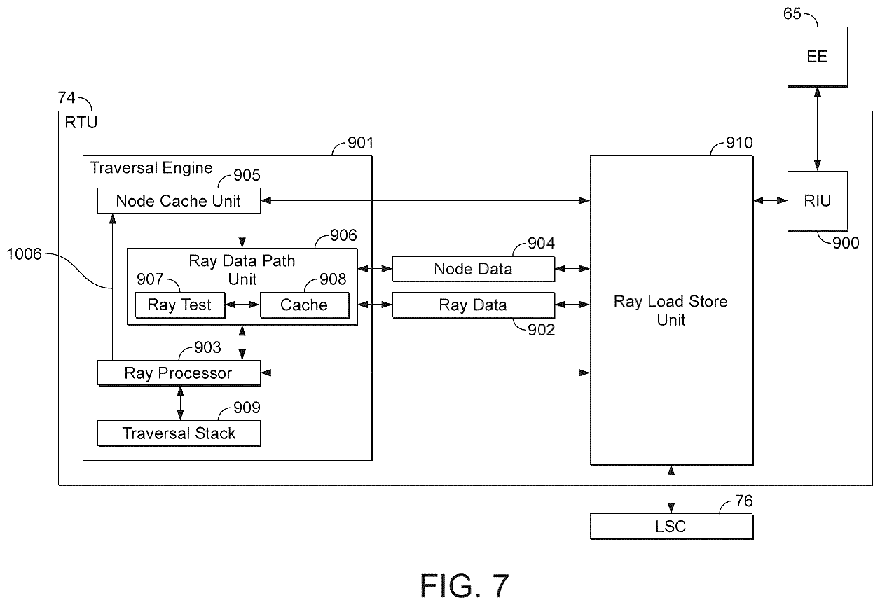

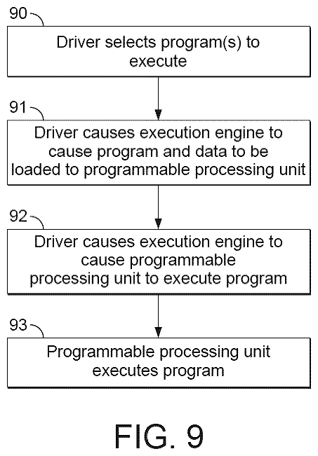

FIG. 7 shows the ray tracing unit (circuit) (RTU) 74 in more detail. The ray tracing unit 74 in particular performs the ray tracing acceleration data structure traversals for rays that are to be traced, and includes, as shown in FIG. 9, a traversal engine (unit) 901 for doing that.

The traversal engine 901 includes in particular a ray testing circuit (in the form of a ray data path unit) 906 that performs the ray-node (intersection) tests necessary for the traversal operations. To do this, the ray testing circuit (ray data path unit) 906 includes a plurality of ray testing units (circuits) 907, each operable to perform a particular type of ray-node test.

In the present embodiments, the ray testing circuit (ray data path unit) 906 includes as its ray testing units 907, four ray testing units configured to perform tests for non-end (non-leaf) nodes (“box” nodes) of a ray tracing acceleration data structure, one ray testing unit configured to perform ray-node tests for end (leaf) nodes that indicate a transition from one ray tracing acceleration data structure to another (“transform” nodes), and one ray testing unit configured to perform ray-node tests for end (leaf) nodes of a ray tracing acceleration data structure that indicate actual geometry to be tested (“triangle” nodes).

Other combinations and numbers of ray-node testing units (circuits) would, of course, be possible.

In order to perform the ray-node tests, the respective ray node testing units are provided with the appropriate ray and node data. In order to facilitate this information, data of nodes and rays to be tested is stored locally in the ray tracing unit 74 in a node cache data storing part (which is in the form of an SRAM) 904, and a ray data store (which is in the form of an SRAM) 902, respectively, as shown in FIG. 7. (The node data store 904 is the node data storing part of a node cache of the ray tracing unit 74, with the corresponding node cache tag table being part of the node cache unit 905.)

As shown in FIG. 7, the ray data path unit 906 further includes node storage (a cache) 908 local to the ray data path unit (which storage in the present embodiment is in the form of a set of (staging) registers accessible to the ray tracing units of the ray data path unit 906), in which ray tracing acceleration structure node data is stored for use by the ray testing units 907 when performing ray-node tests.

As shown in FIG. 7, the traversal engine 901 in addition to the ray data path unit 906 also includes a ray processing unit (ray processor) 903 that has an associated traversal stack 909, and a node cache unit/controller 905.

The ray processing unit 903 controls the overall traversal process for rays that are to be traced by the traversal unit 901. The traversal stack 909 is used to keep track of the traversal progress of rays that are being traced through a ray tracing acceleration data structure. The node cache unit 905 operates to coordinate and schedule the actual ray-node tests on the ray data path unit 906, and to, inter alia, ensure that the appropriate ray and node data is provided to the desired ray testing unit for the required ray-node tests.

As discussed above, the tracing of rays by the ray tracing unit 74 is triggered by appropriate messages from the execution engine 65 (in response to “ray tracing” instructions in a shader program that the execution engine is executing). To facilitate this, as shown in FIG. 7, the ray tracing unit 74 includes a ray instruction unit (RIU) 900 that receives the messages from the execution engine 65 of a shader core when ray tracing is to be performed for respective rays. (The ray instruction unit 900 correspondingly returns respective rays to the execution engine 65 for further processing when required (as discussed above).)

In response to a message from the execution engine 65 to perform ray tracing for a ray or rays, the ray instruction unit 900 controls a ray load store unit (RLSU) 910 to create an appropriate set of one or more rays to be processed.

For each ray to be traced, the ray load store unit 910 allocates an (internal) ID for the ray and loads the relevant ray data to the ray data store (ray SRAM) 902.

The ray load store unit 910 then signals the ray processing unit 903 to perform the required ray tracing acceleration data structure traversal for the ray.

The ray data store 902 has an entry for each (supported) (internal) ray ID and stores the relevant ray data for the ray having the allocated (internal) ID that the entry corresponds to. Each ray data store entry also has an associated validity indication, for indicating whether the entry stores currently valid ray data or not.

In the present embodiment, the ray data store has a capacity to store 128 rays (so 128 (internal) ray IDs are available for allocation for rays to be tested) and is configured as 4 banks of 32 rays each, with one ray being able to be read from each bank in a given processing cycle (such that four rays, one from each bank, can be read from the ray data store 902 in parallel). Other capacities, sub-divisions, and configurations of the ray data store 902 would, of course, be possible.

The node data store 904 acts as the data storing part of a node cache of the ray tracing unit 74, and, accordingly includes a plurality of entries (cache lines), each operable and configured to store data of a node or nodes of a ray tracing acceleration data structure. In the present embodiment, the node cache data store 904 has a capacity to store 256 entries (cache lines) and is configured as 2 banks, with each bank storing 512 bits (64 bytes) of node data for the node cache entry (cache line) in question (so each cache entry (line) in effect comprises 2 sub-lines of 64 bytes each, one in each cache bank). In the present embodiments, each triangle node and each transform node is assumed to occupy an entire cache line (so both banks of a node cache entry/line), whereas each box node is assumed to occupy only one bank (only one sub-line) of a node cache entry.

Node data is able to be read from each bank in a given processing cycle (such that 2 sets (each comprising 64 bytes) of node data, one from each bank, can be read from the node cache data store 904 in parallel).

Other capacities, sub-divisions, and configurations of the node data store 904 would, of course, be possible.

Node data is loaded into the node data store 904 (the node cache) by the ray load store unit in response to requests to do that sent by the node cache unit 905. As shown in FIG. 7, the ray load store unit 910 accordingly has an appropriate interface with the node cache data store 904.

As shown in FIG. 7, the ray load store unit 910 has an appropriate interface to the load store cache 76 via which it can, inter alia, load ray data from the memory system into the ray data store 902, and load node data from the memory system into the node data store 904, as and when required.

The ray processing unit (circuit) 903 receives the rays to be processed from the ray load store unit 910 and causes the traversal engine 901 to traverse the rays through the appropriate ray tracing acceleration data structure(s) until an appropriate stop condition is reached (essentially either that the ray's traversal has been completed or that the ray needs to be returned to the execution engine 65 for appropriate shader execution (as discussed above)).

To facilitate this, as discussed above, the ray processing unit 903 uses a traversal stack 909 to keep track of the traversals of the rays that are currently being tested, and in particular of the next node that a given ray being processed is to be tested against.

When a ray reaches a stop condition, the ray processing unit 903 signals the ray load store unit 910 to that effect, and the ray load store unit appropriately “retires” the ray from the ray tracing unit 74. This may comprise, for example, and in an embodiment, de-allocating the ray ID, writing any necessary ray data from the ray data store 902 back to the memory system (via the load store cache 76) and notifying the ray instruction unit 900 that the ray has been retired (with the ray instruction unit 900 then signalling the execution engine 65 accordingly).

As discussed above, the ray data path unit 906 performs the appropriate ray/node tests for processing the rays and includes appropriate ray-node testing units (circuits) 907 for this purpose.

The ray data path unit 906 performs the ray-node testing under the control of the node cache unit 905. The ray processing unit 903 issues messages to the node cache unit 905 indicating a ray and ray tracing acceleration data structure node combination that is to be tested by the ray data path unit 906.

The node cache unit 905 ensures that the necessary ray and ray tracing acceleration data structure node data is available to the ray data path unit 906 and schedules the ray-node testing on to the ray data path unit accordingly.

Once it has tested a ray-node combination, the ray data path unit 906, as shown in FIG. 7, informs the ray processing unit 903 accordingly (e.g. for the ray processing unit to then identify and trigger the next ray-node test for the ray in question or to identify that a stop condition for the ray has been reached). The ray data path unit 906 may also, as shown in FIG. 7, write any resulting ray data from its testing to the ray data store 902, for example for returning to memory via the load store cache 76, as appropriate.

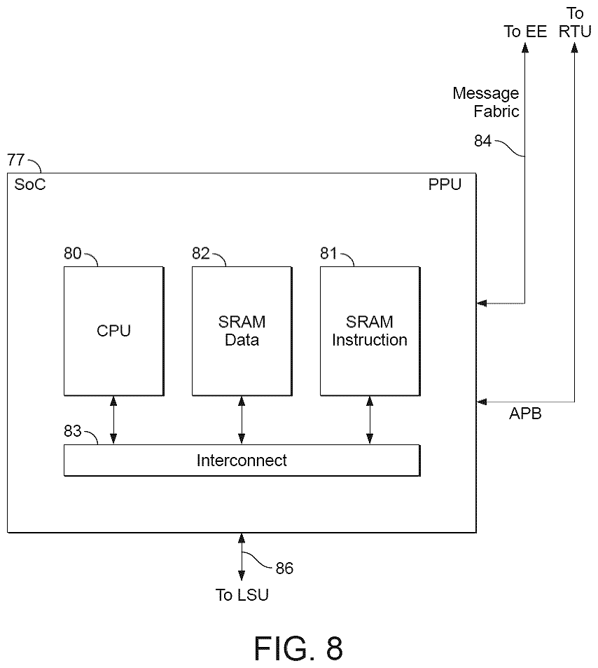

FIG. 8 shows the programmable processing unit 77 in more detail.

As can be seen from FIG. 8, the programmable processing unit in the present embodiments is in the form of a (small) system-on-chip (SoC) that comprises a processor 80 (in the form of a (small) CPU) that is operable to execute program instructions to perform processing operations, together with appropriate storage 81 for storing programs (program instructions) for execution by the processor 80, and storage 82 for storing data used by and generated by the processor 80 when executing a program, together with an appropriate interconnect 83 whereby the various units of the programmable processing unit 77 can communicate with each other.

As shown in FIG. 8 (and in FIG. 6) the programmable processing unit 77 has limited communication (interfaces) with other elements of the shader core 61.

As shown in FIGS. 8 and 6, it firstly has a communication interface 84 to the execution engine 65. In the present embodiments, this interface is provided via and to a message fabric of the shader core (via which “message fabric” the execution engine communicates with other components of the shader core, such as the RTU 74, the load/store unit 76, and other hardware units (accelerators) of the shader core, such as a texture unit, attribute unit and/or varying unit (not shown)).

This interface and communication with the execution engine is used to load programs (program instructions) for execution into the instruction store 81 of the programmable processing unit 77, to load data for use by the processor 80 when executing a program to the data store 82 of the programmable processing unit 77, and for the execution engine 65 to control the operation of the programmable processing unit (for example, and in an embodiment, to control its execution of programs in use).

As shown in FIGS. 6 and 8, the programmable processing unit 77 also has a communications interface 85 with the RTU 74. In the present embodiments, this interface allows the programmable processing unit to read information stored locally by the RTU 74, such as, and in an embodiment, information relating to the performance of ray tracing acceleration data structure traversals by the RTU 74, and also to write (control) data to control and modify the operation of the RTU 74. In the present embodiments, this interface allows the programmable processing unit 77 to read particular registers of the RTU 74, and to write data to particular (control) registers of the RTU 74, and comprises an APB (Advanced Peripheral Bus) interface.

Finally, as shown in FIGS. 6 and 8, the programmable processing unit 77 also has a communications interface 86 to the load/store unit 76, whereby it can write data generated by the execution of a program by the programmable processing unit 77 to the memory system of the overall graphics processing system.

In operation of the graphics processor 60 in the present embodiments, the programmable processing unit will be caused to execute programs relating to the operation of the ray tracing unit 74, in accordance with the technology described herein. This operation will be discussed in more detail below with reference to FIGS. 9 to 11.

For this operation, an appropriate program or programs to be executed by the programmable processing unit 77 is first loaded into the instruction storage 81 of the programmable processing unit. In the present embodiments, this is done via and under the control of the execution engine 65. Thus, the execution engine 65 will cause an appropriate program or programs to be loaded into the instruction storage 81 of the programmable processing unit. This is done via the communications interface 84 between the execution engine and the programmable processing unit 77.

The program or programs that are loaded to the programmable processing unit for execution are, in the present embodiments, selected from a library of suitable programs that have previously been prepared. The driver 11 for the graphics processor 60 selects an appropriate program or programs from the library and then instructs the execution engine 65 accordingly to load the relevant program instructions into the instruction store 81 of the programmable processing unit 77. Correspondingly, any data necessary for the program execution is loaded into the data storage 82 of the programmable processing unit.

FIG. 9 illustrates this, and shows the driver 11 selects an appropriate program or programs for the programmable processing unit to execute (step 90). This may be based, for example, on the ray tracing-based rendering that the graphics processor is currently being required to perform.

The driver then causes the execution engine to cause the appropriate program instructions and any data to be loaded to the storage of the programmable processing unit (step 91).

Once that is done, the driver can then control the execution engine to cause the programmable processing unit to execute the desired program (step 92).

The programmable processing unit will then execute the required program (step 93).

In a first embodiment, the program that the programmable processing unit 77 executes is a program that performs processing to (try to) improve the operation of the ray tracing unit 74 when performing ray tracing operations.

In this embodiment, the programmable processing unit 77 executes a program to observe (monitor) the traffic/workload on the ray tracing unit 74 when performing ray tracing operations, and that is operable to provide information for trying to improve the operation of the ray tracing circuit based on the observed traffic/workload of the ray tracing circuit. For example, the performance in one frame could be observed and used to set control information for the next frame.

To do this, the programmable processing unit 77 as part of its program execution reads appropriate performance monitoring information (from registers of the ray tracing unit 74) that is generated and stored by the ray tracing unit 74 when performing ray tracing acceleration data structure traversals, and using this information maintains a record of information per ray tracing acceleration data structure node type, so as to identify which nodes are the most used, and the relative proportions of different node types being tested (for the traversal operations being observed).

The program that the programmable processing unit is executing then uses the (observed) node information to generate “hints” and set control information for (trying to) improve the operation of the ray tracing unit when performing its ray tracing operations.

In the present embodiment, the program is configured to generate “hints” (control information) relating to a priority in which node data stored in a cache of the ray tracing circuit should be replaced (the cache replacement policy for a cache of the ray tracing circuit) (e.g. to (try to) reduce the number of cache misses); the control and selection of data to be pre-fetched into a cache of the ray tracing circuit (the cache pre-fetching operation for the ray tracing circuit) (e.g. to (try to) reduce the cache stalling time); the order (priority) for scheduling ray-node tests to be performed by the ray tracing circuit (e.g., and in an embodiment, in terms of the priority for performing different types of ray-node tests) (e.g., and in an embodiment, so as to try to improve the ray testing circuit utilisation); and the traversal mode to be used when traversing a ray tracing acceleration data structure (e.g., and in an embodiment, in terms of the order in which nodes of the ray tracing acceleration data structure are tested, e.g., and in an embodiment, relating to whether the closest node or the farthest node is tested first (so as to try to improve the amount of resume flow for “any hit” shader/non-opaque hits, as well as early termination for first hits)).

It then returns this information to the appropriate (control) units of the ray tracing unit.

To do this, in the present embodiment the programmable processing unit has access to local storage (registers) that store (control) data for controlling the relevant, e.g. cache, operation of the ray tracing unit 74 (control registers of the ray tracing unit), so as to allow the programmable processing unit to set and/or modify control information for the (units of the) ray tracing unit accordingly.

The ray tracing unit will then use these “hints” (control information) to control (e.g. to modify) its operation accordingly, thereby (the intention is) to improve the, e.g. efficiency of, the operation of the ray tracing circuit when performing its ray tracing operations.

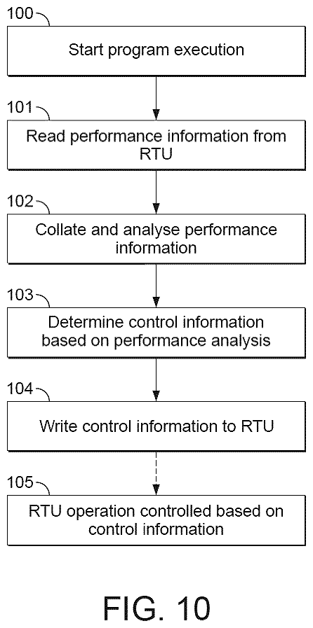

FIG. 10 illustrates this, and shows that once the program execution has been started (step 100), the programmable processing unit will read appropriate performance information from the ray tracing unit 74 (step 101).

The program being executed will then collate and analyse that performance information (step 102) and determine appropriate control information for the ray tracing unit 74 based on the analysis of the performance information (step 103).

The program will then cause the programmable processing unit to write appropriate control information to the ray tracing unit 74 (step 104), to modify the operation based on the analysed performance of the ray tracing unit 74.

The ray tracing unit's operation will then be controlled based on the control information generated by the program execution (step 105).

In another embodiment, the program that the programmable processing unit 77 executes causes the programmable processing unit to generate (part of) a ray tracing acceleration data structure (that may then be traversed by the ray tracing unit 74 when performing ray tracing processing).

In this case, the programmable processing unit executes a program that executes a fixed algorithm for building a ray tracing acceleration data structure (and that generates a relatively small ray tracing acceleration data structure (treelet), for which the generated data can (all) be stored in the local data storage of the programmable processing unit).

Once the ray tracing acceleration data structure has been generated and stored in the local (data) storage of the programmable processing unit, the programmable processing unit is caused to write out the ray tracing acceleration data structure that it has built to be written out to memory.

In the present embodiments, and as discussed above, the programmable processing unit has a communications path and interface to a load/store unit (circuit) of the graphics processor for this purpose (which load/store unit has access to and is operable to write data to and from the (overall) memory system (via an appropriate cache hierarchy)).

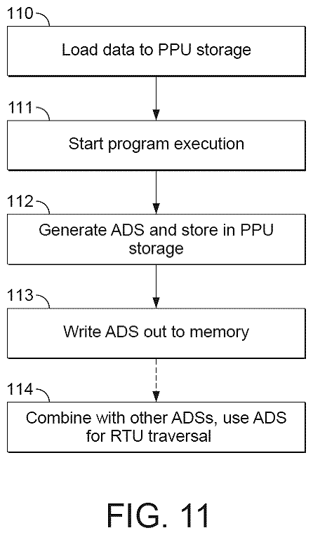

FIG. 11 illustrates this. As shown in FIG. 11, the programmable execution unit will firstly load appropriate data to the storage of the programmable processing unit 77 to be used when generating the required ray tracing acceleration data structure (step 110), and then trigger the appropriate ray tracing acceleration data structure generation program execution (step 111).

The program execution will then generate a ray tracing acceleration data structure using, inter alia, the data loaded to the programmable processing unit, and store the generated acceleration data structure in the (local) storage of the programmable processing unit 77 (step 112).

Once the ray tracing acceleration data structure has been generated, it is then written out from the programmable processing unit to memory (step 113), where it can then, e.g., be combined (agglomerated) with other ray tracing acceleration data structures to provide an overall, desired “full” ray tracing acceleration data structure that can then be used by the ray tracing unit 74 when performing ray tracing (step 114).

It can be seen from the above that the technology described herein, in its embodiments at least, can provide for improved operations when performing ray tracing using a graphics processor. This is achieved, in the embodiments of the technology described herein at least, by providing a programmable processing unit in association with a ray tracing circuit that accelerates ray tracing traversal operations, which programmable processing unit is programmable to and caused to execute programs relating to the operation of the ray tracing circuit.

The foregoing detailed description has been presented for the purposes of illustration and description. It is not intended to be exhaustive or to limit the technology to the precise form disclosed. Many modifications and variations are possible in the light of the above teaching. The described embodiments were chosen in order to best explain the principles of the technology and its practical application, to thereby enable others skilled in the art to best utilise the technology in various embodiments and with various modifications as are suited to the particular use contemplated. It is intended that the scope be defined by the claims appended hereto.

1. A graphics processor that is operable to generate a render output by performing a ray tracing process in which rays are traced through a scene to be rendered,
wherein the ray tracing process for a ray involves performing a traversal of at least one ray tracing acceleration data structure to determine geometry that is intersected or potentially intersected by the ray;
the graphics processor comprising:
a programmable execution unit operable to execute graphics processing programs to perform rendering that includes performing a ray tracing process;
a ray tracing circuit operable to test rays against a ray tracing acceleration data structure for a ray tracing process; and
a programmable processing unit associated with and in communication with the ray tracing circuit, and configured to execute processing programs to perform processing relating to the operation of the ray tracing circuit.

2. The graphics processor of claim 1, wherein the programmable processing unit comprises a processor that can execute programs to perform processing operations, storage for storing a program or programs for execution by the processor and storage for storing data to be used by the processor when executing a program and/or for storing data that is generated by the processor when executing a program.

3. The graphics processor of claim 1, wherein the programmable execution unit is operable to cause a program for performing processing relating to the operation of the ray tracing circuit to be loaded into storage of the programmable processing unit.

4. The graphics processor of claim 1, wherein:
the programmable execution unit is operable to cause data required for the execution of a program by the programmable processing unit to be loaded into storage of the programmable processing unit.

5. The graphics processor of claim 1, wherein:
the programmable execution unit is operable to cause the programmable processing unit to execute a processing program to perform processing relating to the operation of the ray tracing circuit.

6. The graphics processor of claim 1, wherein:
the programmable execution unit is configured to communicate with the programmable processing unit via the same communications interface that the programmable execution unit uses to communicate with the ray tracing circuit of the graphics processor.

7. The graphics processor of claim 1, wherein:
the programmable processing unit is programmable to perform processing relating to ray tracing acceleration data structure traversal operations that are being performed by the ray tracing circuit.

8. The graphics processor of claim 1, wherein:
the programmable processing unit has communications interface(s) with the ray tracing circuit to allow it to monitor the performance of the ray tracing circuit when performing ray tracing acceleration data structure traversals, and to provide control information to the ray tracing circuit for the ray tracing circuit to then use when performing ray tracing acceleration data structure traversals.

9. The graphics processor of claim 1, wherein:
the programmable processing unit is programmable to perform processing to generate a ray tracing acceleration data structure.

10. The graphics processor of claim 1, wherein:
the programmable processing unit has a communications interface to allow ray tracing acceleration data structure data generated by the programmable processing unit to be written out to memory.

11. A method of operating a graphics processor that is operable to generate a render output by performing a ray tracing process in which rays are traced through a scene to be rendered,
wherein the ray tracing process for a ray involves performing a traversal of at least one ray tracing acceleration data structure to determine geometry that is intersected or potentially intersected by the ray;
the graphics processor comprising:
a programmable execution unit operable to execute graphics processing programs to perform rendering that includes performing a ray tracing process; and
a ray tracing circuit operable to test rays against a ray tracing acceleration data structure for a ray tracing process; and
a programmable processing unit associated with and in communication with the ray tracing circuit, and configured to execute processing programs to perform processing relating to the operation of the ray tracing circuit;
the method comprising:
loading a program for performing processing relating to the operation of the ray tracing circuit into program storage of the programmable processing unit; and
causing the programmable processing unit to execute the program to perform processing relating to the operation of the ray tracing circuit.

12. The method of claim 11, further comprising loading data for performing processing relating to the operation of the ray tracing circuit into storage of the programmable processing unit; and
the programmable processing unit then using that data when executing a program to perform processing relating to the operation of the ray tracing circuit.

13. The method of claim 11, further comprising loading a program for performing processing relating to the operation of the ray tracing circuit into program storage of the programmable processing unit to replace an existing program stored in the program storage of the programmable processing unit; and
the programmable processing unit then executing the new program to perform processing relating to the operation of the ray tracing circuit.

14. The method of claim 11, comprising:
the programmable execution unit causing the programmable processing unit to execute a processing program to perform processing relating to the operation of the ray tracing circuit.

15. The method of claim 11, comprising:
the programmable execution unit communicating with the programmable processing unit via the same communications interface that the programmable execution unit uses to communicate with the ray tracing circuit of the graphics processor.

16. The method of claim 11, comprising:
causing the programmable processing unit to execute a program that performs processing relating to ray tracing acceleration data structure traversal operations that are being performed by the ray tracing circuit.

17. The method of claim 16, comprising the programmable processing unit, when executing the program:
monitoring the performance of ray tracing acceleration data structure traversals by the ray tracing circuit; and
determining information for then providing to the ray tracing circuit for trying to improve its ray tracing acceleration data structure traversal operation based on the monitoring.

18. The method of claim 11, comprising:
causing the programmable processing unit to execute a program that performs processing to generate a ray tracing acceleration data structure.

19. The method of claim 18, comprising:
the programmable processing unit causing ray tracing acceleration data structure data generated by the programmable processing unit when executing the program to be written out to memory.

20. A non-transitory computer readable storage medium storing computer software code which when executing on one or more processors performs a method of operating a graphics processor that is operable to generate a render output by performing a ray tracing process in which rays are traced through a scene to be rendered,
wherein the ray tracing process for a ray involves performing a traversal of at least one ray tracing acceleration data structure to determine geometry that is intersected or potentially intersected by the ray;
the graphics processor comprising:
a programmable execution unit operable to execute graphics processing programs to perform rendering that includes performing a ray tracing process; and
a ray tracing circuit operable to test rays against a ray tracing acceleration data structure for a ray tracing process; and
a programmable processing unit associated with and in communication with the ray tracing circuit, and configured to execute processing programs to perform processing relating to the operation of the ray tracing circuit;
the method comprising:
loading a program for performing processing relating to the operation of the ray tracing circuit into program storage of the programmable processing unit; and
causing the programmable processing unit to execute the program to perform processing relating to the operation of the ray tracing circuit.
